(19) United States
(12) Patent Application Publication
(10) Pub. No.: US 2008/0005262 A1
(43) Pub. Date: Jan. 3, 2008

(54) Peripheral Sharing USB Hub for a Wireless Host

(76) Inventors: Henry Wurzburg, Austin, TX (US); Mark R. Bohm, Village of Bear Creek, TX (US); Mark Y. Fu, Newark, CA (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/424,772

(22) Filed: Jun. 16, 2006

(51) Int. Cl. G06F 15/16

(52) U.S. Cl. 709/217

(57) ABSTRACT

In various embodiments, a wireless host and a wired host may communicate with downstream devices through a USB switching hub. A wireless host/wireless bridge may be temporarily physically coupled to an upstream port of the USB switching hub to complete association with another wireless bridge coupled to the USB switching hub as a downstream device through a downstream port. During association, the host and downstream wireless bridge may exchange an encryption key to be used for future wireless communications. After association, the wireless host may be disconnected from the USB switching hub to communicate remotely. In some embodiments, the wireless host may not need to be physically coupled to the USB switching hub during association.

### BACKGROUND OF THE INVENTION

1. Field of the Invention

The present invention relates generally to computer hardware and, more specifically, to Universal Serial Bus (USB) switching hubs.

2. Description of the Related Art

The Universal Serial Bus (USB) allows coupling of peripheral devices to a computer system. USB is a serial cable bus for data exchange between a host computer and a wide range of simultaneously accessible devices. The bus allows peripherals to be attached, configured, used, and detached while the host is in operation. For example, USB printers, scanners, digital cameras, storage devices, card readers, etc. may communicate with a host computer system over USB. USB based systems may require that a USB host controller be present in the host system, and that the operating system (OS) of the host system support USB and USB Mass Storage Class Devices.

USB devices may communicate over the USB bus at low-speed (LS), full-speed (FS), or high-speed (HS). A connection between the USB device and the host may include four wires (a power line, a ground line, and a pair of data lines (D+ and D−). When a USB device connects to the host, the USB device may first pull a D+ line high (the D− line if the device is a low speed device) using a pull up resistor on the D+ line. The host may respond by resetting the USB device. If the USB device is a high-speed USB device, the USB device may “chirp” by driving the D− line high during the reset. The host may respond to the “chirp” by alternately driving the D+ and D− lines high. The USB device may then electronically remove the pull up resistor and continue communicating at high speed. When disconnecting, full-speed devices may remove the pull up resistor from the D+ line (i.e., “tri-state” the line), while high-speed USB devices may tri-state both the D+ and D− lines.

A USB hub may be coupled to a USB host controller to allow multiple USB devices to be coupled to the host system through the USB host controller. In addition, other USB hubs may be coupled to the USB hub to provide additional USB device connections to the USB host controller.

Some dual role peripheral devices may include a slave controller and be capable of communicating with other peripheral devices coupled to them. For example, a dual role USB printer may be able to communicate directly with a USB camera to print pictures from the USB camera. The dual role USB printer may also be accessible (e.g., by a computer system) as a slave peripheral device. If a computer system and dual role peripheral device need to alternately access a peripheral device, the peripheral device may need to be unplugged from one device and coupled to the other. Prior art device switches may not work for high-speed peripheral devices. For example, mechanical switches may introduce too much capacitance or inductance to work with high-speed peripheral devices. High-speed peripheral devices also typically require smooth impedance to prevent ringing (mechanical switches introduce irregularities in the impedance that may cause ringing).

The Wireless USB specification (revision 1.0 and 1.1) defines wireless USB. Part of Wireless USB is the requirement for “association” where the USB host may be introduced to a device either by the user entering a code of some sort, or via a wired means so the host and the device can communicate over a secure means prior to communicating over the wireless medium. A media access controller (MAC) may have a device port on it for association and a main data connection port for data transfer after the radio has been associated. The device port may be a dedicated port for attachment to a USB host for association only, and may have no other functionality. The channelization scheme presented in the Wireless USB specification, version 1.1, also references the ability to share the radio with other communication protocols such as Bluetooth.

### SUMMARY OF THE INVENTION

In various embodiments, communications between each of the downstream ports and two or more upstream ports may be controlled by a USB switching hub. In some embodiments, devices coupled to upstream ports (e.g., wired and/or wireless hosts) of a USB switching hub may enumerate the USB switching hub according to the total number of downstream ports on the USB switching hub. In some embodiments, when first upstream port is communicating with a first downstream port, a second upstream port may be communicating with a different downstream port (as determined by a communication configuration implemented in switching logic in the USB switching hub). In some embodiments, when the first upstream port is communicating with the first downstream port, the second upstream port may perceive the first downstream port as disconnected. For example, status registers coupled to the second upstream port may indicate the first downstream port is disconnected (i.e., to appear that no device is electrically connected to the first downstream port). The disconnect status may prevent the second upstream device from attempting to reset and connect to a downstream device coupled to the first downstream port while a separate upstream device is communicating through the first upstream port with the first downstream device. By enumerating the USB switching hub according to the total number of downstream ports, the upstream devices may not have to re-enumerate the hub (and correspondingly each device coupled to the hub) each time a downstream device is switched.

In various embodiments, a wireless host (e.g., a laptop with a wireless bridge and transceiver) and a wired host may communicate with downstream devices through the USB switching hub. Communications between the downstream devices and the wireless host may pass through wireless bridges coupled to wireless transceivers between the wireless host and the USB switching hub. In some embodiments, multiple wireless hosts may communicate with downstream devices through the USB switching hub through one or more wireless bridges coupled to one or more upstream ports of the USB switching hub.

In some embodiments, the USB switching hub may be used to perform association (i.e., exchanging an encryption key to insure secure communications) between the wireless host and a wireless bridge coupled to the USB switching hub. A wireless host/wireless bridge may be temporarily physically coupled to the upstream port to complete association with a wireless bridge coupled to the USB switching hub as a downstream device through a downstream port. Other association methods are also possible (e.g., exchanging a code manually between the two wireless bridges without temporarily physically coupling the two together). The wireless bridge that stays coupled to the USB switching hub during wireless communications may be internal to the USB switching hub. The wireless bridge may also communicate as a downstream device during association through a reversible port that may reverse to allow communications between the wireless bridge and the USB switching hub as an upstream device. During association, the wireless bridges may exchange an encryption key to be used for future wireless communications.

### BRIEF DESCRIPTION OF THE DRAWINGS

A better understanding of the present invention may be obtained when the following detailed description is considered in conjunction with the following drawings, in which:

FIG. 1 illustrates a USB switching hub, according to an embodiment;

FIG. 2 illustrates a computer system coupled to a USB switching hub, according to an embodiment;

FIG. 3 illustrates a computer system and a dual role peripheral device coupled to a USB switching hub, according to an embodiment;

FIGS. 4a and 4b illustrate two communication configurations of the USB switching hub, according to an embodiment;

FIGS. 5a, 5b, and 5c illustrate additional communication configurations of the USB switching hub, according to an embodiment;

FIG. 6 illustrates unified functions within the USB switching hub, according to an embodiment;

FIG. 7 illustrates a method for switching access to a downstream port between two upstream ports, according to an embodiment;

FIG. 8 illustrates a USB switching hub with multiple status registers, according to an embodiment;

FIG. 9 shows a method for switching access to a downstream port between two upstream ports without reenumerating the USB switching hub, according to an embodiment;

FIG. 10 shows a method for monitoring a standby state to approve a communication switch, according to an embodiment;

FIG. 11 shows a method for monitoring hub transactions to approve a communication switch, according to an embodiment;

FIG. 12 shows a method for switching communications at a frame boundary, according to an embodiment;

FIG. 13 illustrates a computer system and a dual role peripheral device coupled to a USB switching hub, according to an alternate embodiment;

FIGS. 14a and 14b illustrate two communication configurations of the USB switching hub, according to an alternate embodiment;

FIGS. 15a, 15b, and 15c illustrate additional communication configurations of the USB switching hub, according to an alternate embodiment;

FIG. 16 illustrates a USB switching hub with multiple status registers, according to an alternate embodiment;

FIG. 17 illustrates an alternate embodiment of a computer system and a peripheral device coupled to a USB switching hub;

FIGS. 18a, 18b, and 18c illustrate the USB switching hub communicatively coupling to a wireless host, according to an embodiment;

FIGS. 18d and 18e illustrate various embodiments of the hub and switching logic;

FIG. 19 illustrates the USB switching hub with an internal wireless bridge, according to an embodiment;

FIG. 20 illustrates the USB switching hub with an internal wireless bridge and internal transceiver, according to an embodiment;

FIG. 21 illustrates the USB switching hub coupled to a plurality of wireless hosts, according to an embodiment;

FIG. 22 illustrates the USB switching hub with a reversible port, according to an embodiment;

FIG. 23 illustrates a method of using the USB switching hub to support a wireless host, according to an embodiment;

FIG. 24 illustrates a method for using the USB switching hub for associating a wireless host, according to an embodiment;

FIG. 25 illustrates a method for using the USB switching hub for supporting multiple wireless hosts, according to an embodiment; and

FIG. 26 illustrates a method for using the USB switching hub with a reversing PHY to support a wireless bridge as a downstream device during association and an upstream device during regular communications, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (e.g., having the potential to or being able to in some embodiments), not a mandatory sense (i.e., must). The term “include”, and derivations thereof, mean “including, but not limited to”. The term “coupled” means “directly or indirectly connected”.

### DETAILED DESCRIPTION OF EMBODIMENTS OF THE INVENTION

### Incorporation by Reference

U.S. patent application Ser. No. 11/424,179 titled “Peripheral Sharing USB Hub” filed on Jun. 14, 2006, whose inventors are Mark R. Bohm, Mark Y. Fu, Henry Wurzburg, James E. Bowles, Robert E. Hollingsworth, Drew J. Dutton, and Akhlesh Nigam, is hereby incorporated by reference as though fully and completely set forth herein.

U.S. patent application Ser. No. 11/100,299 titled “Peripheral Sharing USB Hub” filed on Apr. 6, 2005, whose inventors are Mark R. Bohm, Mark Fu, Henry Wurzburg, James E. Bowles, Robert E. Hollingsworth, and Drew J. Dutton, is hereby incorporated by reference as though fully and completely set forth herein.

U.S. patent application Ser. No. 10/940,406 titled “Universal Serial Bus Switching Hub” filed on Sep. 14, 2004, whose inventors are Henry Wurzburg, James E. Bowles, Robert E. Hollingsworth, Mark R. Bohm, and Drew J. Dutton is hereby incorporated by reference as though fully and completely set forth herein.

U.S. patent application Ser. No. 11/412,431 titled “System and Method for Universal Serial Bus Hub Port Reversal” filed on Apr. 27, 2006, whose inventors are Mark R. Bohm, Donald L. Perkins, and Carl J. Crawford is hereby incorporated by reference as though fully and completely set forth herein.

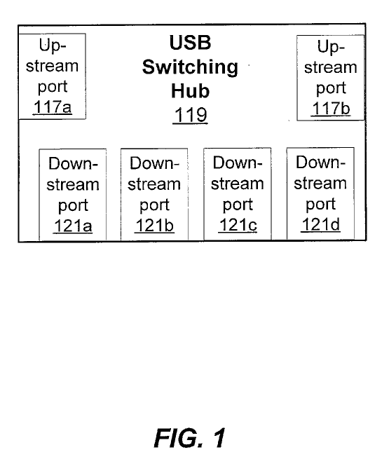

FIG. 1 illustrates an embodiment of a USB switching hub. In various embodiments, USB switching hub 119 may control access between two or more upstream ports 117 on USB switching hub 119 and at least a subset of downstream ports 121 on USB switching hub 119. In some cases, a numeric label may be used to refer to a collection of similar elements, or to a generic version of the element (e.g., “downstream ports 121” may be used to reference one or more downstream ports 121a, 121b, 121c, and 121d).

In some embodiments, upstream devices coupled to upstream ports 117 may enumerate USB switching hub 119 according to the total number (N) of downstream ports 121. For example, USB switching hub 119 may be enumerated as a 4-port hub (corresponding to the four downstream ports 121). In some embodiments, communications between each of downstream ports 121 and upstream ports 117 may be controlled by USB switching hub 119. In some embodiments, when first upstream port 117a is communicating with first downstream port 121a, second upstream port 117b may communicate with second downstream port 121b. Second upstream port 117b may register first downstream port 121a as disconnected. For example, status registers coupled to second upstream port 117b may indicate first downstream port 121a is disconnected (i.e., to appear that no device is electrically connected to first downstream port 121a). The disconnect status may prevent second upstream device 117b from attempting to reset and connect to first peripheral device 121a coupled to first downstream device 121a while a separate upstream device is communicating through first upstream port 117a with first downstream device 125a. By enumerating USB switching hub 119 as a 4-port hub, the upstream devices may not have to re-enumerate USB switching hub 119 (and correspondingly each downstream and/or upstream device coupled to the USB switching hub) each time a downstream device is switched.

In some embodiments, only one upstream device may access any one downstream device at a time. In some embodiments, multiple upstream devices may access separate downstream devices at the same time. In some embodiments, different communication configurations may be implemented. For example, first upstream port 117a may be allowed access to the first three downstream ports (121a, 121b, and 121c) and second upstream port 117b may be allowed access to fourth downstream port 121d. Devices coupled to first upstream port 117a and second upstream port 117b may have enumerated USB switching hub 119 as a 4-port hub, but in this example, a device coupled to first upstream port 117a may register fourth downstream port 121d as disconnected while a device coupled to second upstream port 117b may register the first three downstream ports (121a, 121b, and 121c) as disconnected.

In a second communication configuration, first upstream port 117a may be allowed to access fourth downstream port 121d while second upstream port 117b may be allowed to access the first three downstream ports (121a, 121b, and 121c). Other communication configurations are also possible (e.g., in one communication configuration neither upstream port 117 may be allowed to access any downstream port 121). In some embodiments, USB switching hub 119, after receiving a control signal (e.g., from a computer, a different attached device, a person, a sensor, a logic internal to USB switching hub 119, etc.), may switch between the first communication configuration and the second communication configuration (or another communication configuration). In some embodiments, USB switching hub 119 may not receive a control signal before switching communication configurations (e.g., switching access for first downstream device 125a from first upstream port 117a to second upstream port 117b).

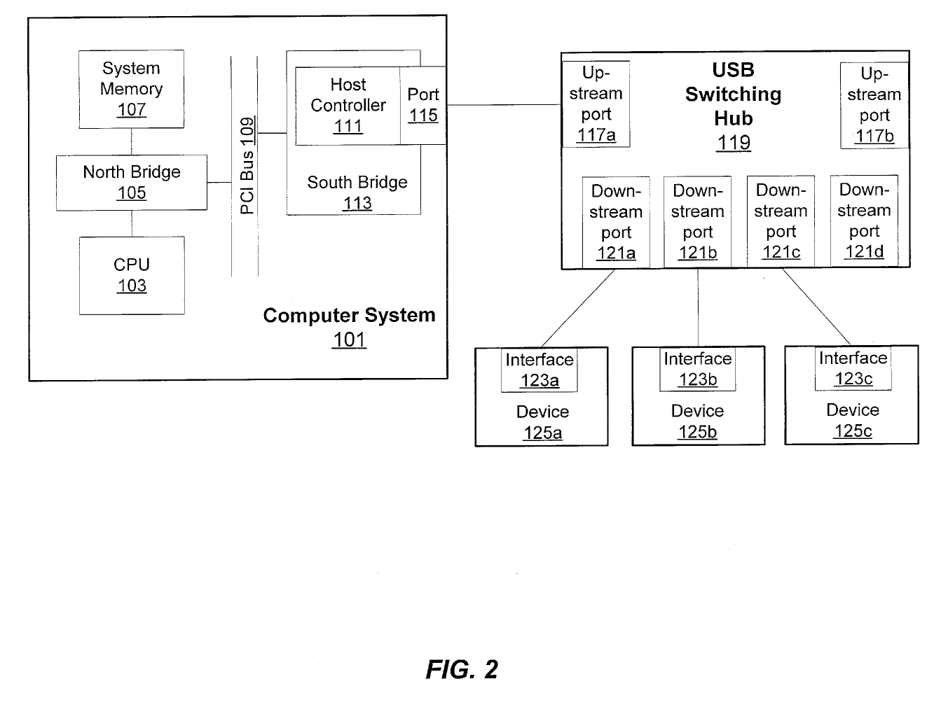

FIG. 2 illustrates an embodiment of computer system 101 coupled to USB switching hub 119. In some embodiments, computer system 101 (e.g., a personal computer (PC), laptop, server, etc.) may access multiple peripheral devices 125 coupled to USB switching hub 119. Computer system 101 may couple to USB switching hub 119 through upstream port 117a. Computer system 101 may receive and transmit signals, e.g., USB signals, through host controller 111 coupled to device port 115. While various embodiments may include computer system 101, it is to be understood that other devices that have a host controller may also access USB switching hub 119. Host controller 111, coupled to south bridge 113, may be coupled to other computer components (e.g., north bridge 105, central processing unit (CPU) 103, and system memory 107) through peripheral component interconnect (PCI) bus 109.

In some embodiments, USB switching hub 119 may have multiple downstream ports 121 for coupling to multiple peripheral devices 125. Peripheral devices 125 may include USB printers, scanners, digital cameras, digital camera docks, consumer audio/video, storage devices, and card readers, among others. In some embodiments, peripheral devices 125 may couple to USB switching hub 119 through interface 123. In some embodiments, interface 123 may be a PHY interface. Other interfaces may also be used (e.g., UTMI or ULPI). Upstream ports 117 and downstream ports 121 may also have interfaces.

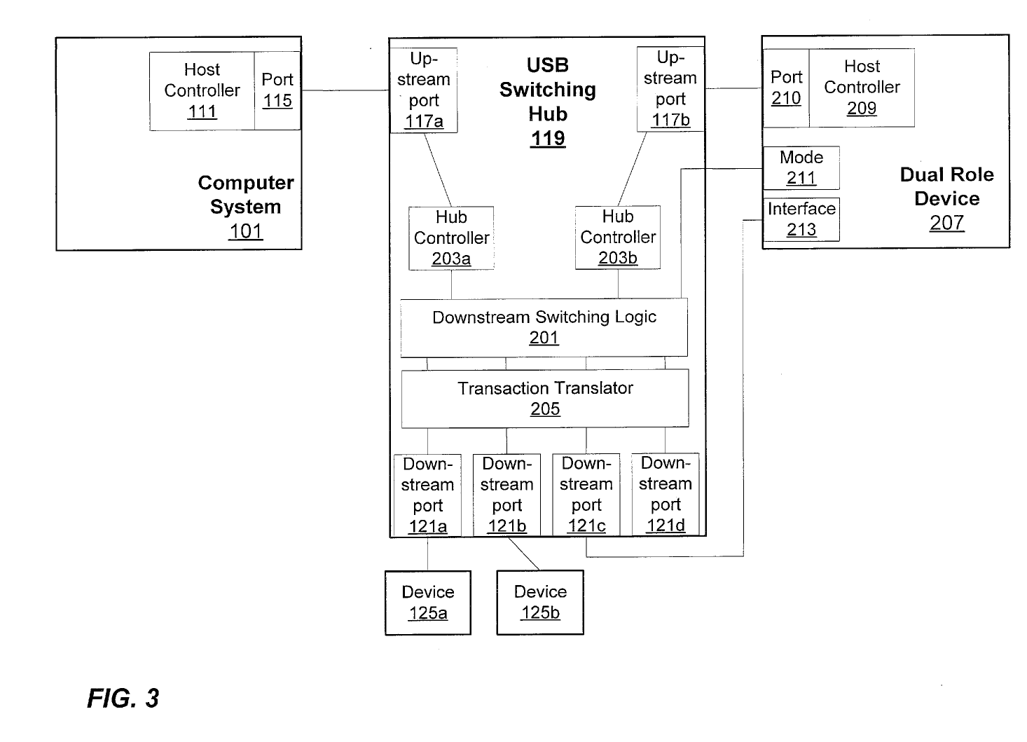

FIG. 3 illustrates an embodiment of two upstream devices (e.g., computer system 101 and dual role peripheral device 207) coupled to USB switching hub 119. In some embodiments, USB switching hub 119 may include downstream switching logic 201, coupled to one or more hub controllers 203 (e.g., hub controllers 203a and 203b). Downstream switching logic 201 may also be coupled to transaction translator circuitry 205. Transaction translator 205 may be electronically coupled to downstream ports 121. In some embodiments, downstream switching logic 201 may switch between two or more communication configurations. Communication configurations may be implemented by downstream switching logic 201 routing communications between upstream ports 117 and downstream ports 121 while the communications are in the digital domain (as a result of the interfaces to/from USB switching hub 119). In some embodiments, communication configurations (e.g., hardwired in the USB switching hub) may be switched as determined by logic on the USB switching hub. Other communication configuration implementations are also contemplated.

In some embodiments, dual role peripheral device 207 may include a dual role USB printer or dual role USB Digital Versatile Disc (DVD) read/write drive, among others. In some embodiments, dual role peripheral device 207 may be coupled to an upstream port (e.g., upstream port 117b) of USB switching hub 119 through device port 210. Dual role peripheral device 207 may interface through upstream port 117b with other peripheral devices (downstream peripheral devices) coupled to USB switching hub 119 (e.g., using host controller 209 on dual role peripheral device 207). Dual role peripheral device 207 may also interface with other upstream devices (such as computer system 101) through a slave controller. For example, dual role peripheral device 207 may be coupled to USB switching hub 119 as a slave peripheral device (e.g., through downstream port 121c). In some embodiments, dual role peripheral device 207, coupled to the USB switching hub, may simultaneously act as a host to one or more peripheral devices and/or as slave peripheral device to a separate host.

In some embodiments, dual role peripheral device 207 may have an embedded host controller application to operate as a standalone system (e.g., to communicate with another peripheral device, such as a digital camera, without PC intervention). For example, a dual role USB printer may print pictures directly from a digital camera, coupled to a downstream port 121 on USB switching hub 119, without PC intervention. In some embodiments, USB switching hub 119 may alternately allow the computer system 101 or dual role peripheral device 207 to access one or more downstream devices (e.g., by switching between one or more communication configurations).

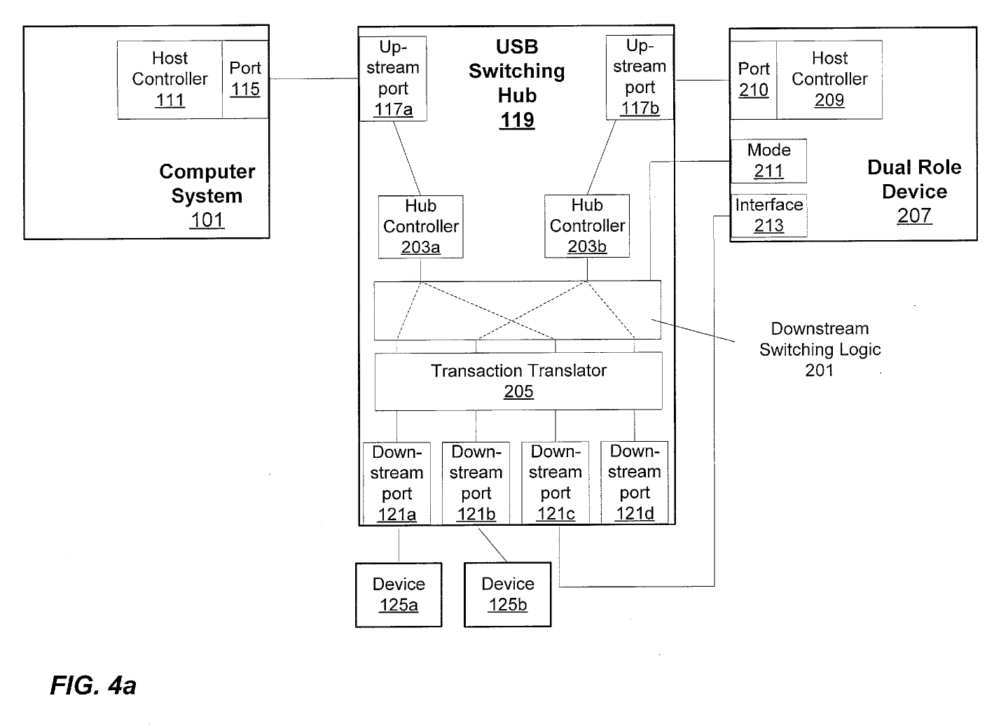

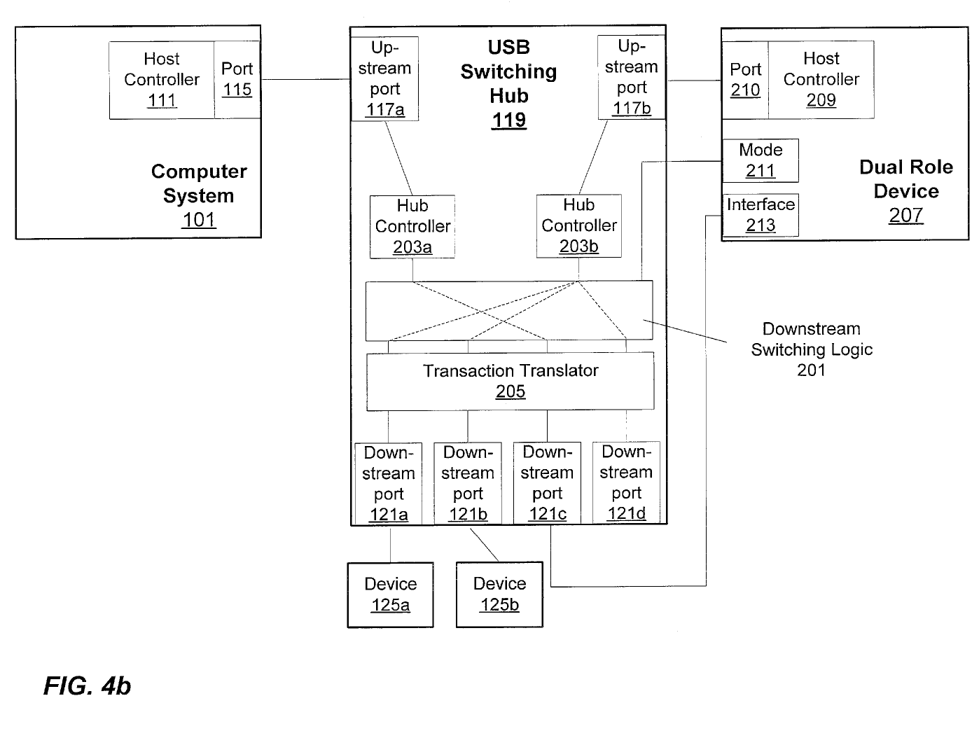

FIG. 4a illustrates an embodiment of a computer system 101 electronically coupled to multiple peripheral devices 125. In some embodiments, USB switching hub 119 may act like a switch coupling multiple internal “hubs” that may share one or more downstream ports. For example, each potential communication configuration of the USB switching hub may represent an internal “hub”. In some embodiments, when computer system 101 is accessing peripheral device 125 (e.g., peripheral device 125a) coupled to USB switching hub 119, communications to/from the peripheral device may be processed through a first “hub” comprised of first upstream port 117a, hub controller 203a, transaction translator 205, and at least a subset of the downstream ports 121. A second “hub” may be comprised of second upstream port 117b, hub controller 203b, transaction translator 205, and at least a subset of the downstream ports 121. In one communication configuration, computer system 101 may connect to downstream ports 121a and 121c (through the first “hub”), and dual role peripheral device 207 may connect to downstream ports 121b and 121d (through the second “hub”) (as seen in FIG. 4b). Other communication configurations are also contemplated. In some embodiments, communication configuration profiles designating which downstream devices to couple to each upstream port may be hardwired or implemented by software. For example, if implemented by software, communication configuration profiles for each upstream port (and/or upstream device) may be stored on a memory accessible to USB switching hub 119.

In some embodiments, computer system 101 and dual role peripheral device 207 may communicate through USB switching hub 119 simultaneously with separate downstream devices. For example, while computer system 101 communicates with device 125a (e.g., through the first “hub”), dual role peripheral device 207 may communicate with device 125b (e.g., through the second “hub”). In some embodiments, while peripheral device 125a is being accessed through the first “hub”, a different upstream device may not be able to access peripheral device 125a (e.g., dual role peripheral device 207 may not be able to access peripheral device 125a while peripheral device 125a is being used by computer system 101). In some embodiments, a signal (e.g., from an external control block) may trigger downstream switching logic 201 to switch access for a subset of downstream ports 121 (e.g., downstream port 121a and/or 121c) on the first “hub” to the second “hub” (i.e., switch communication configurations). In some embodiments, dual role peripheral device 207 may send a control signal to USB switching hub 119. USB switching hub 119 may then switch communication configurations to connect one or more downstream ports to the dual role peripheral device. For example, when a user presses a button on dual role peripheral device 207 (e.g., a dual role printer), a signal may be sent through mode 211 to downstream switching logic 201 to switch access of device 125a from computer system 101 to dual role peripheral device 207 (i.e., to switch to a second communication configuration as seen in FIG. 4b). Computer system 101 may continue to communicate with downstream port 121c (and/or other downstream ports as determined by the second communication configuration).

In some embodiments, when activity is no longer detected between dual role peripheral device 207 and a downstream port (e.g., if dual role peripheral device 207 is turned off), downstream switching logic 201 may switch access of the downstream port to computer system 101 (i.e., switch to a different communication configuration). In some embodiments, downstream switching logic 201 may switch access of the downstream port to a different upstream device. In some embodiments, instead of detecting inactivity, a signal from dual role peripheral device 207 may signal USB switching hub 119 to switch. Other signals and/or logic may also be used in determining when to switch communication configurations.

In some embodiments, communication configurations may be software implemented. In some embodiments, a microprocessor coupled to or comprised in downstream switching logic 201 may dynamically determine, e.g., using a dynamic communication configuration profile, which downstream ports to electrically couple to each upstream port. For example, the microprocessor may read a stored communication configuration profile and attempt to connect upstream ports to downstream ports according to the communication configuration profile. The communication configuration profiles may be stored on a memory (e.g., an Electronically Erasable Programmable Read-Only Memory (EEPROM)) coupled to USB switching hub 119. In some embodiments, hub controllers 203 on USB switching hub 119 may have access to the communication configuration profiles.

In some embodiments, a priority logic may be used to switch communication configurations. Priority logic, or other logic used to grant access, may be internal or external to USB switching hub 119. In some embodiments, computer system 101 may be given priority over all of downstream ports 121 until an external control signal is sent from dual role peripheral device 207 to switch access of one or more downstream ports 121 to dual role peripheral device 207. In some embodiments, different control signals may be sent to trigger different communication configurations (i.e., to switch access of different downstream ports to dual role peripheral device 207).

In some embodiments, host negotiation logic may be used to determine which communication configuration to use. In some embodiments, a default communication configuration may be used until multiple upstream devices “request” access to the same downstream port. Host negotiation logic may be used to determine which communication configuration to use (i.e., which communication configuration gives a particular upstream port access to the “requested” downstream port).

In some embodiments, a microprocessor in USB switching hub 119 may include a built in algorithm that auto detects downstream peripheral devices and determines how to connect the downstream peripheral devices. For example, instead of assigning a specific downstream port to an upstream port, a communication configuration profile may specify that the upstream port should have access to a digital camera if one is attached. The built in algorithm may auto-detect the digital camera when it is attached to one of the downstream ports and attach it to the appropriate upstream port (i.e., by switching to an appropriate communication configuration).

In some embodiments, when downstream switching logic 201 switches communication configurations, and control of a downstream port is switched from computer system 101 to dual role peripheral device 207, a connection between computer system 101 and respective peripheral device 125 (coupled to the downstream port to be switched) may be terminated by computer system 101. In some embodiments, communications between the downstream port to be switched and computer system 101 may be terminated by USB switching hub 119. Dual role peripheral device 207 may then connect to, enumerate, and communicate with the respective peripheral device 125 coupled to the switched downstream port.

Upstream devices may see downstream ports that they are not configured to attach to as unattached ports (i.e., active, but with no device connected). In some embodiments, if only a predetermined number of downstream ports is ever going to be attached to a particular upstream port (e.g., a number “x” ports), the upstream device may be signaled that the hub only has x ports. For example, if upstream port 117b is only going to be configured to attach to downstream ports 121c and 121d, a device attached to upstream port 117b may be signaled that USB switching hub 119 is only a two port hub.

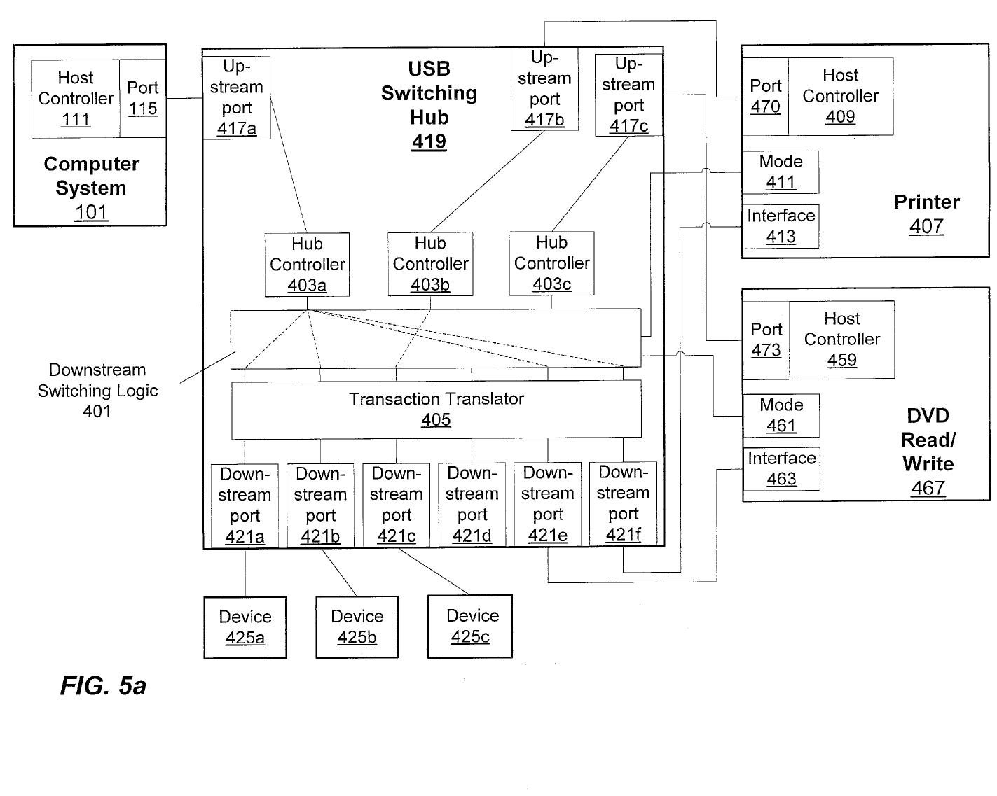

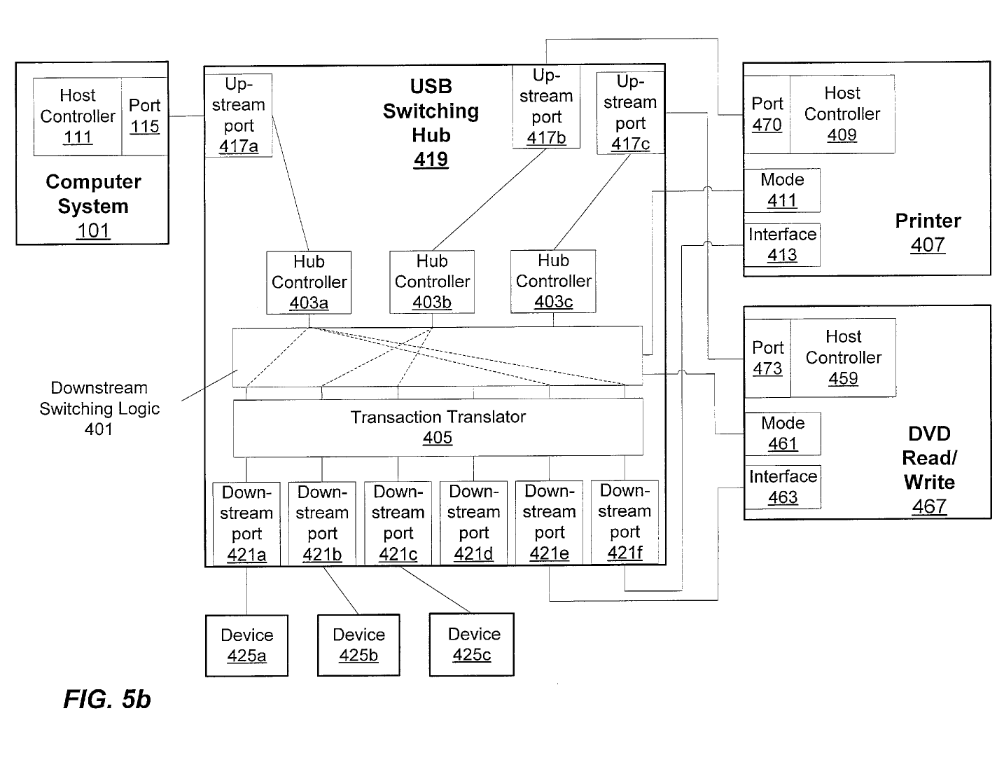

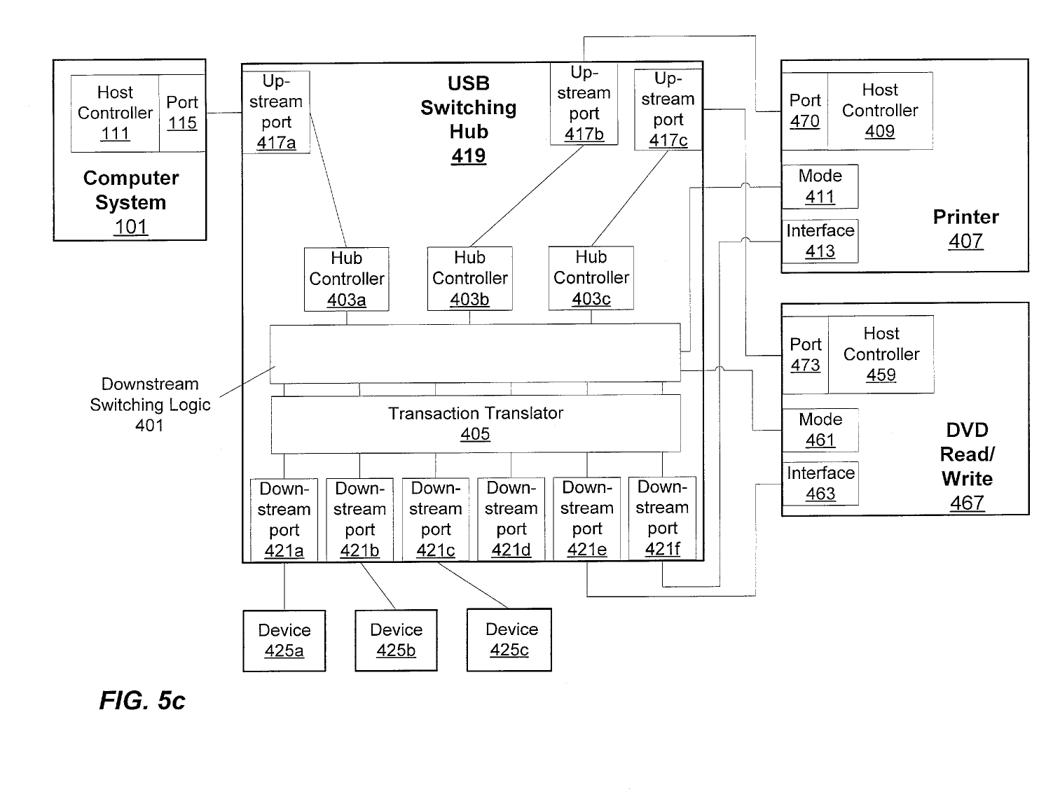

FIGS. 5a, 5b, and 5c illustrate various embodiments of computer system 101 and two dual role peripheral devices coupled to USB switching hub 419. In some embodiments, multiple dual role peripheral devices may be coupled to USB switching hub 419. For example, dual role printer 407 may be coupled to USB switching hub 419 through upstream port 417b and dual role DVD read/write drive 467 may be coupled to USB switching hub 419 through upstream port 417c. Computer system 101 may be coupled to USB switching hub 419 through upstream port 417a. Each of the upstream devices may be coupled to a respective hub controller 403, downstream switching logic 401, and transaction translator 405. Downstream switching logic 401 may configure communications between each of the upstream devices (i.e., computer system 101, dual role printer 407, or dual role DVD read/write drive 467) and at least a subset of the peripheral devices 425.

As seen in FIG. 5a, in one communication configuration profile, the computer system 101 may be connected to downstream ports 421a, 421b, 421e, and 421f. In an embodiment, dual role printer 407 may be configured to access downstream port 421c, and DVD read/write drive 467 may be configured not to access any downstream port 421. Dual role printer 407 may gain access (i.e., have the communication configuration switched to give it access) to downstream port 421b through several different methods. For example, a user may press a button on dual role printer 407. A signal may then be sent through mode 411 to downstream switching logic 401 in USB switching hub 419. Downstream switching logic 401 may switch to the communication configuration seen in FIG. 5b (which allows dual role printer 407 to access downstream port 421b). In some embodiments, if dual role printer 407 is turned off or becomes inactive, downstream switching logic 401 may switch access of downstream port 421b back to computer system 101 (i.e., switch back to the previous communication configuration). As seen in FIG. 5c, in one communication configuration, none of the upstream ports may be allowed to access any of the downstream ports.

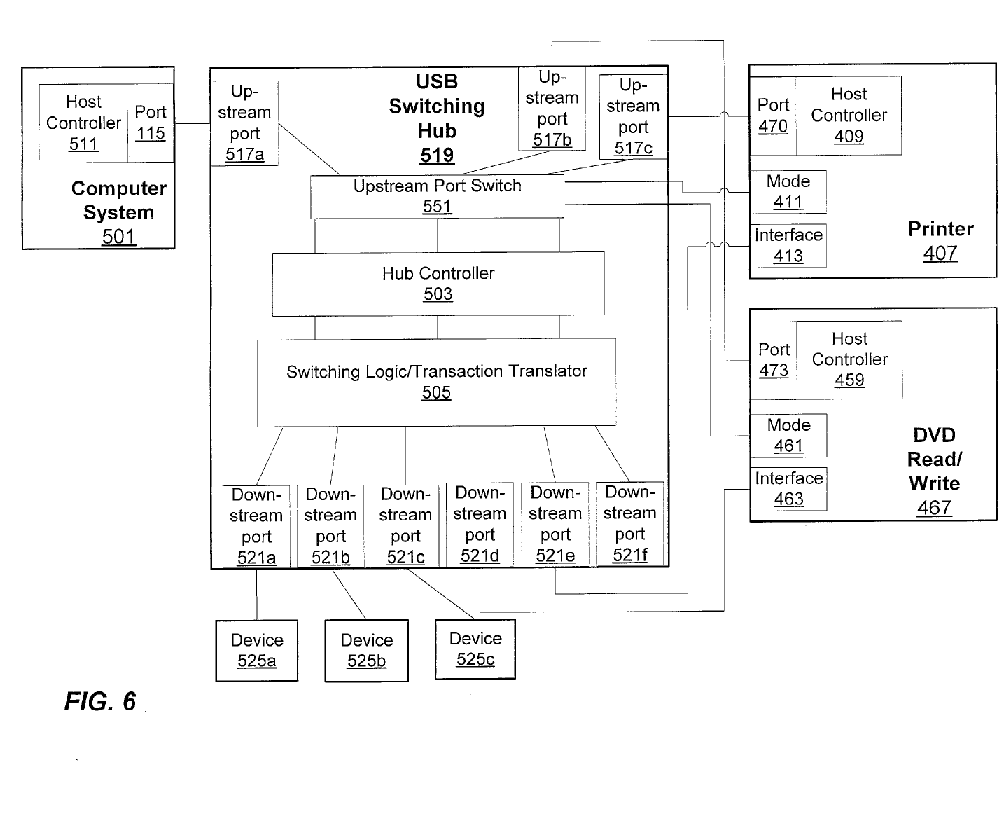

FIG. 6 illustrates an embodiment of unified functions within the USB switching hub. In some embodiments, instead of separate hub controllers, unified hub controller 503 may be used. For example, instead of separate hub controllers handling communications for their respective upstream port, a unified hub controller may handle communications for each of the upstream ports. Similarly, unified transaction translator 505 may be used for each respective upstream port. Also, as seen in FIG. 6, in some embodiments, an upstream port switch 551 may be used. For example, the upstream port switch 551 may implement various communication configurations instead of a downstream switching logic.

In some embodiments, transaction translator(s) in the USB switching hub (e.g., USB switching hub 419 or USB switching hub 519) may allow upstream ports to communicate at different communication speeds relative to the other upstream ports. For example, one upstream port may be coupled only to high speed devices and, therefore, communicate at high speed, while a separate upstream port may be coupled to only full speed devices and, therefore, communicate at full speed. In some embodiments, upstream ports may be able to communicate with different downstream ports at different speeds because of the transaction translators.

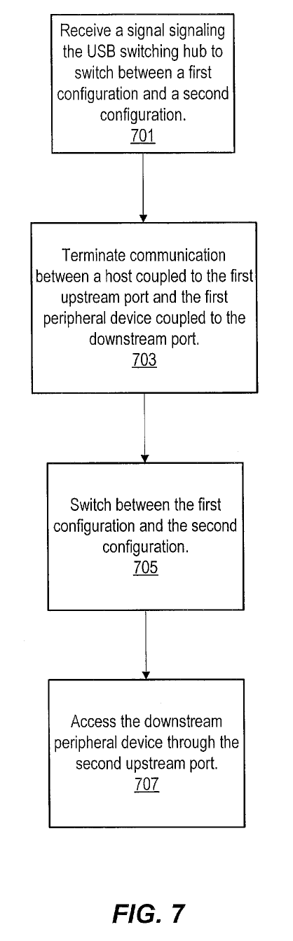

FIG. 7 shows an embodiment of a method for switching access to a downstream port between two upstream ports on the USB switching hub. It should be noted that in various embodiments of the methods described below, one or more of the elements described may be performed concurrently, in a different order than shown, or may be omitted entirely. Other additional elements may also be performed as desired.

At 701, the USB switching hub may receive a signal (e.g., an external control signal) signaling the USB switching hub to switch between a first communication configuration and a second communication configuration. For example, switching communication configurations may switch access of a first downstream port from a first upstream port to a second upstream port. In some embodiments, a user may press a button on a dual role peripheral device coupled to the USB switching hub, and the dual role peripheral device may send an external control signal to the USB switching hub to signal the USB switching hub to switch between one or more communication configurations. In some embodiments, the signal may be internal (e.g., generated by logic internal to the USB switching hub).

At 703, communication between a host coupled to the first upstream port and the first peripheral device coupled to the first downstream port may be terminated. In some embodiments, communication may be terminated for a subset of the downstream peripheral devices.

At 705, the USB switching hub may switch between the first communication configuration and the second communication configuration to give access of the first downstream port to the second upstream port. In some embodiments, the communication configuration switch may affect access for a subset of the downstream peripheral devices.

At 707, the downstream peripheral device coupled to the first downstream port may be accessed through the second upstream port by the host coupled to the second upstream port. In some embodiments, the second upstream port may communicate with a subset of the downstream peripheral devices. For example, the host may enumerate and then communicate with the switched multiple downstream devices. In some embodiments, access between the first upstream port and a second downstream port may continue.

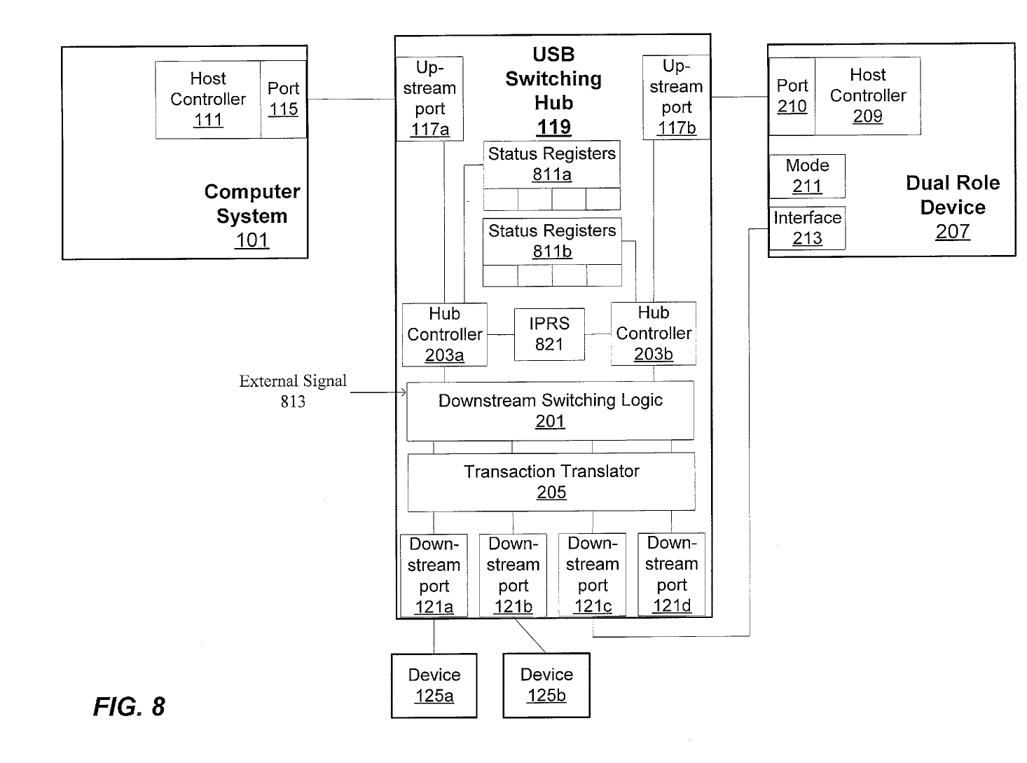

FIG. 8 illustrates a USB switching hub with multiple status registers, according to an embodiment. In some embodiments, upstream devices (e.g., computer system 101 and dual role device 207) may communicate with downstream devices 125 through downstream ports 121. In some embodiments, each upstream device may enumerate USB switching hub 119 as a 4-port hub (or according to the number of downstream ports 121 on the USB switching hub 119). In some embodiments, external signal 813 may signal downstream switching logic 201 to switch communications for a subset of downstream ports 121 (e.g., downstream ports 121a and 121b). When communications are being switched, a status register (e.g., a status register in a set of status registers 811a) may indicate a disconnect status for the previously connected downstream port). In some embodiments, communications between the downstream port and the second upstream device may then be established. For example, activity from downstream port 121a may indicate a connect event on a status register for downstream port 121a in the second set of status registers 811b. The second upstream device (e.g., dual role device 207) may detect the “connect” event when it poles status registers 811b and then reset the device coupled to downstream port 121a. While the second upstream device is communicating through downstream port 121a, other upstream devices coupled to other upstream ports may detect a “disconnect” for downstream port 121a when they poll their respective set of status registers 811.

In some embodiments, intelligent port routing switch (IPRS) 821 may delay switching communications for downstream port 125a if there is an active transfer in progress between downstream port 125a and first upstream port 117a. In some embodiments, IPRS 821 may delay switching communications for downstream port 125a if there is an active transfer in progress between downstream port 125 and second upstream port 117b. In some embodiments, IPRS 821 may be implemented in hardware and/or firmware on USB switching hub 119. In some embodiments, the IPRS may be implemented in software on computer system 101. The IPRS may include software and drivers that have knowledge of current USB traffic to delay a request to switch a device that is in use. In some embodiments, the IPRS may be entirely outside of any traffic monitoring internal to USB switching hub 119.

IPRS 821 may delay switching communications between other downstream ports 125 if there are pending or active transfers in progress. In some embodiments, IPRS 821 may monitor communications at the hub controller 203 level or may monitor communications at the downstream switching logic level. Other placements between downstream ports 121 and upstream ports 117 may also be used. In some embodiments, instead of relying on intelligent monitoring or an external method for delaying switching communications, IPRS 821 may operate to delay switching such that switching takes place at the USB frame boundary (when, by definition, no traffic is permitted to be in progress). In such embodiments, switching may be delayed until the frame boundary on a predetermined basis, not as a result of intelligent monitoring.

In some embodiments, external signal 813 (e.g., from a user, from computer system 101, or from mode 211 on dual role device 207) may signal downstream switching logic 201 to switch communications between a downstream port 121 and the upstream ports 117. Other sources of external signal 813 are also contemplated (e.g., the external signal may originate from a physical switch coupled to USB switching hub 119). In some embodiments, the physical switch may have switches, push buttons and/or other mechanical components to allow a user to assign one or more downstream ports 121 to specific upstream port 117. In some embodiments, external signal 813 may be sent from computer system 101. For example, an application executing on computer system 101 may allow a user to interact with computer system 101 to assign one or more downstream ports 121 to specific upstream port 117. In some embodiments, computer system 101 may also receive signals back from USB switching hub 119 to communicate with the user. For example, if there are transfers between a related downstream port and an upstream port, USB switching hub 119 may communicate this status to the user, and USB switching hub 119 may wait until it receives confirmation from the user to proceed with the switch (e.g., a signal may be sent from computer system 101 confirming the switch after a user selects a graphical “Proceed” box on a computer screen coupled to computer system 119.)

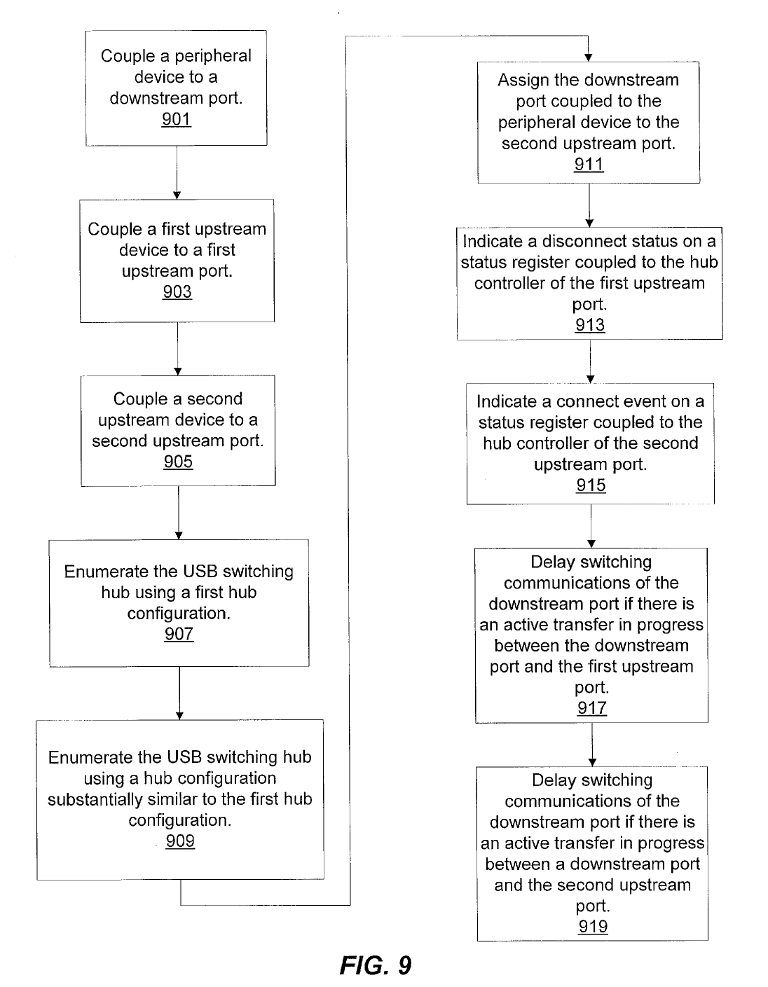

FIG. 9 shows an embodiment of a method for switching access to downstream port 121 between two upstream ports without reenumerating USB switching hub 119. It should be noted that in various embodiments of the methods described below, one or more of the elements described may be performed concurrently, in a different order than shown, or may be omitted entirely. Other additional elements may also be performed as desired.

At 901, a peripheral device may be coupled to a downstream port of a USB switching hub. In some embodiments, the peripheral device may be a USB device. The USB device may also be coupled to an upstream device (i.e., the USB device may be a dual role USB device).

At 903, a first upstream device may be coupled to first upstream port 117a of the USB switching hub 119.

At 905, a second upstream device may be coupled to second upstream port 117b of USB switching hub 119.

At 907, the first upstream device may enumerate USB switching hub 119 using a first hub configuration for USB switching hub 119. For example, if USB switching hub 119 has four downstream ports 121, the first upstream device may enumerate USB switching hub 119 as a 4-port hub. In some embodiments, the first upstream device may enumerate USB switching hub 119 with fewer downstream ports 121 than the total number of downstream ports 121 on USB switching hub 119 (e.g., if one or more downstream ports 121 is permanently inactive or reserved for another use).

At 909, the second upstream device may enumerate USB switching hub 119 using a hub configuration substantially similar to the first hub configuration for USB switching hub 119.

At 911, the downstream port coupled to the peripheral device may be assigned to the second upstream port. In some embodiments, communications between the peripheral device and the first upstream port may be switched to the second upstream port. In some embodiments, if device 125a is a digital camera, it may be initially coupled to computer system 101 (i.e., communications to/from the digital camera may be routed to first upstream port 117a in downstream switching logic 201 while the communications are in the digital domain). External signal 813 (e.g., from a user through computer system 101) may signal downstream switching logic 201 to switch communications between device 125a and two upstream ports 117.

At 913, a disconnect status may be indicated on a status register, corresponding to the switched downstream port, coupled to hub controller 203a of first upstream port 117a. Communications may be terminated between downstream device 125a and an upstream device coupled to first upstream port 117a.

At 915, a connect event may be indicated on a status register, corresponding to the switched downstream port, coupled to hub controller 203b of second upstream port 117b. When second upstream device 207 (e.g., a dual role printer) reads the connect event on the status register, it will reset device 125a coupled to downstream port 121a. Downstream device 125a may connect to upstream device 207 for further communications (e.g., to print pictures directly from the digital camera).

At 917, switching communications of a downstream port 121 may be delayed if there is an active transfer in progress between a downstream port 121 and the first upstream port. Switching communications may be delayed by IPRS 821.

At 919, switching communications of a downstream port 121 may be delayed if there is an active transfer in progress between a downstream port 121 and second upstream port 117b. Switching communications may be delayed by IPRS 821.

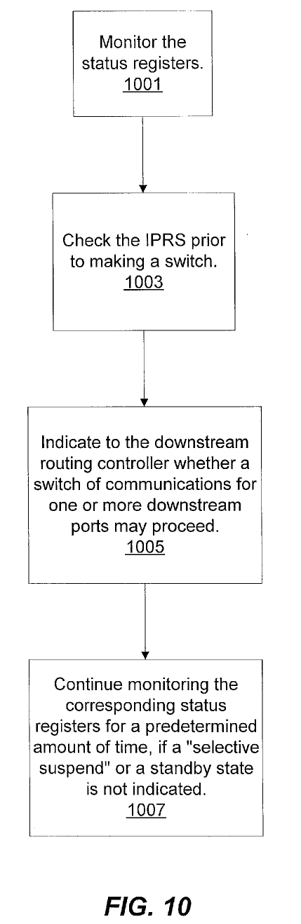

FIG. 10 shows an embodiment of a method for monitoring a standby state to approve a communication switch. It should be noted that in various embodiments of the methods described below, one or more of the elements described may be performed concurrently, in a different order than shown, or may be omitted entirely. Other additional elements may also be performed as desired.

At 1001, IPRS 821 may monitor status registers 811 to determine if peripheral device 125 is actively being used by an upstream device. For example, IPRS 821 may determine if a corresponding status register has a “selective suspend” or a standby state indicated for corresponding downstream port 121.

At 1003, downstream switching logic 201 may check IPRS 821 prior to making a switch for an indication as to whether there are current communications between a downstream port 121 to be switched or between downstream ports 121 coupled to upstream port 117 for which a downstream port 121 will be switched. In some embodiments, downstream switching logic 201 may query IPRS 821 to determine if multiple downstream ports 121 may be switched.

At 1005, IPRS 821 may indicate to downstream switching logic 201 whether a switch of communications for one or more downstream ports 121 may proceed. For example, logic on IPRS 821 may determine which downstream ports 121 the status should be checked (e.g., downstream ports 121 to be switched and downstream ports 121 coupled to the upstream port 117 being switched to). In some embodiments, IPRS 821 may check the corresponding status register when downstream switching logic 201 inquires as to a specific downstream port.

At 1007, if a “selective suspend” or a standby state is not indicated, IPRS 821 may continue to monitor the corresponding status register for a predetermined amount of time after IPRS 821 receives an inquiry from downstream switching logic 201 that a switch is desired. At the end of the predetermined amount of time, if the “selective suspend” or a standby state is still not indicated, IPRS 821 may indicate to downstream port controller 201 that it may switch despite the apparent active status. In some embodiments, if the “selective suspend” or a standby state is not indicated, an indication may be sent to computer system 101 to ask the user if a switch should be made despite the apparent active status of one or more affected peripheral devices 125. If the user approves the switch, downstream switching logic 201 may proceed with the switch.

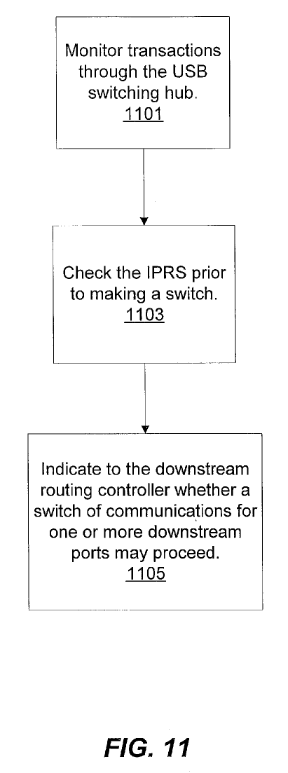

FIG. 11 shows an embodiment of a method for monitoring hub transactions to approve a communication switch. It should be noted that in various embodiments of the methods described below, one or more of the elements described may be performed concurrently, in a different order than shown, or may be omitted entirely. Other additional elements may also be performed as desired.

At 1101, IPRS 821 may monitor transactions through USB switching hub 119 to determine if any of the communications are going to/from relevant peripheral devices (e.g., coupled to a downstream port 121 to be switched or already coupled to upstream port 117 for which peripheral device 125 will be switched to). In some embodiments, the presence of communications and the type of communications may be monitored by IPRS 821. IPRS 821 may monitor communications at any of various points of USB switching hub 119 (e.g., coupled to hub controllers 203, downstream switching logic 201, and/or coupled directly to downstream ports 121 and/or upstream ports 117). IPRS 821 may monitor communications using additional internal logic. In some embodiments, IPRS 821 may not interfere with communications between downstream ports 121 and upstream ports 117.

At 1103, downstream switching logic 201 may check IPRS 821 prior to making a switch for an indication as to whether there are current communications between a downstream port 121 to be switched or between downstream ports 121 coupled to upstream port 117 for which a downstream port 121 will be switched.

At 1105, IPRS 821 may indicate to downstream switching logic 201 whether a switch of communications for one or more downstream ports 121 may proceed.

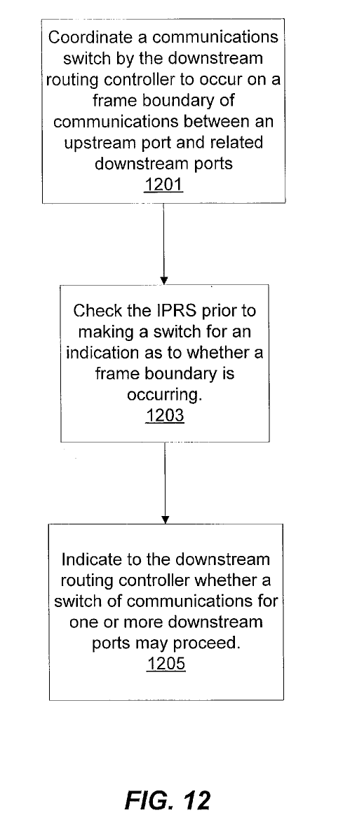

FIG. 12 shows an embodiment of a method for switching communications at a frame boundary. It should be noted that in various embodiments of the methods described below, one or more of the elements described may be performed concurrently, in a different order than shown, or may be omitted entirely. Other additional elements may also be performed as desired.

At 1201, IPRS 821 may coordinate a communications switch by downstream switching logic 201 to occur on a frame boundary of communications between upstream port 117 and related downstream ports 121. In some embodiments, IPRS 821 may interface with one or more hub controllers 203 to determine the timing of the frame boundaries. For example, a microframe timer may be used. In some embodiments, IPRS 821 may interface with other parts of USB switching hub 119 to determine a time to affirm a request to switch from downstream switching logic 201.

At 1203, downstream switching logic 201 may check IPRS 821 prior to making a switch for an indication as to whether a frame boundary is occurring for communications to/from the relevant downstream ports 121.

At 1205, IPRS 821 may indicate to downstream switching logic 201 whether a switch of communications for one or more downstream ports 121 may proceed.

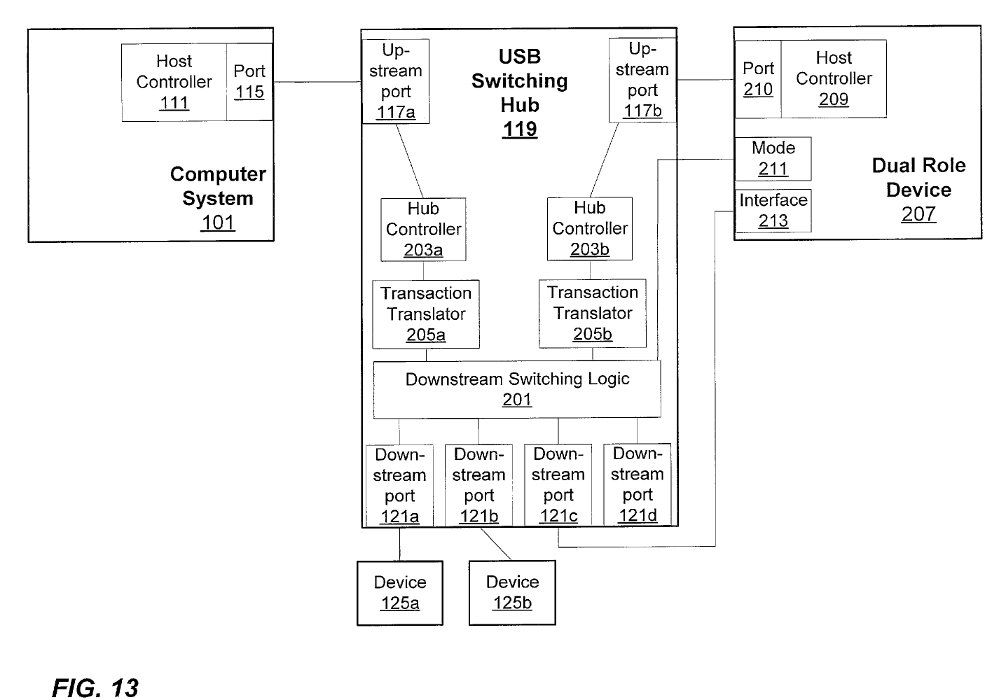

Referring again to FIGS. 3, 4a-4b, 5a-5c, and 8, it should be noted that the positions of the downstream switching logic (201 in FIGS. 3, 4a-4b and 8, and 401 in FIGS. 5a-5c) and the transaction translator logic (205 in FIGS. 3, 4a-4b and 8, and 405 in FIGS. 5a-5c) with respect to each other may be reversed, that is, the transaction translator logic may be configured between the hub controller(s) and the downstream switching logic. Furthermore, an individual transaction translator block may be configured for each upstream port (and corresponding hub controller.) Examples of alternate embodiments showing this configuration are found in FIGS. 13, 14a-14b, 15a-15c, and 16.

FIG. 13 illustrates an alternate embodiment of the configuration shown in FIG. 3, in which two upstream devices (e.g., computer system 101 and dual role peripheral device 207) are coupled to USB switching hub 119. In some embodiments, USB switching hub 119 may include respective transaction translator circuitry 205a and 205b for each upstream port 117a and 117b, coupled to corresponding hub controller 203a and 203b, respectively. Transaction translator circuitry 205a and 205b may also be coupled to downstream switching logic 201, which may be electronically coupled to downstream ports 121. In some embodiments, downstream switching logic 201 may switch between two or more communication configurations. Communication configurations may be implemented by downstream switching logic 201 routing communications between upstream ports 117 and downstream ports 121 while the communications are in the digital domain (as a result of the interfaces to/from USB switching hub 119), as also described for the embodiment of FIG. 3. In some embodiments, communication configurations (e.g., hardwired in the USB switching hub) may be switched as determined by logic on the USB switching hub. Other communication configuration implementations are also contemplated.

As also described for the embodiment of FIG. 3, in some embodiments, dual role peripheral device 207 may include a dual role USB printer or dual role USB Digital Versatile Disc (DVD) read/write drive, among others. In some embodiments, dual role peripheral device 207 may be coupled to an upstream port (e.g., upstream port 117b) of USB switching hub 119 through device port 210. Dual role peripheral device 207 may interface through upstream port 117b with other peripheral devices (downstream peripheral devices) coupled to USB switching hub 119 (e.g., using host controller 209 on dual role peripheral device 207). Dual role peripheral device 207 may also interface with other upstream devices (such as computer system 101) through a slave controller. For example, dual role peripheral device 207 may be coupled to USB switching hub 119 as a slave peripheral device (e.g., through downstream port 121c). In some embodiments, dual role peripheral device 207, coupled to the USB switching hub, may simultaneously act as a host to one or more peripheral devices and/or as slave peripheral device to a separate host.

In some embodiments, dual role peripheral device 207 may have an embedded host controller application to operate as a standalone system (e.g., to communicate with another peripheral device, such as a digital camera, without PC intervention). For example, a dual role USB printer may print pictures directly from a digital camera, coupled to a downstream port 121 on USB switching hub 119, without PC intervention. In some embodiments, USB switching hub 119 may alternately allow the computer system 101 or dual role peripheral device 207 to access one or more downstream devices (e.g., by switching between one or more communication configurations).

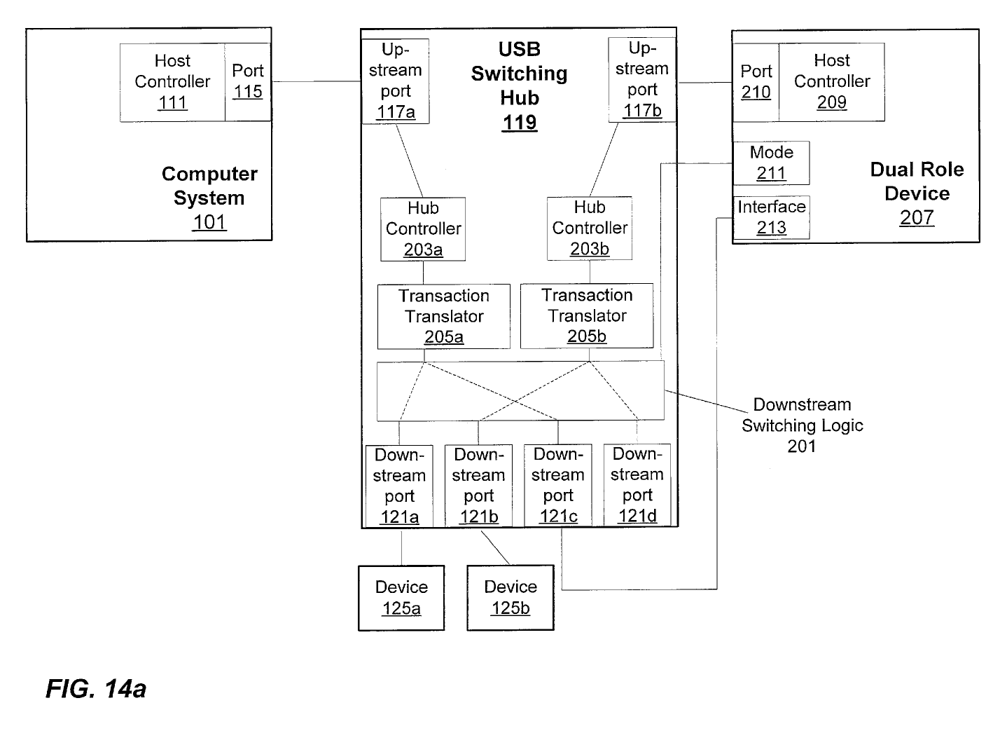

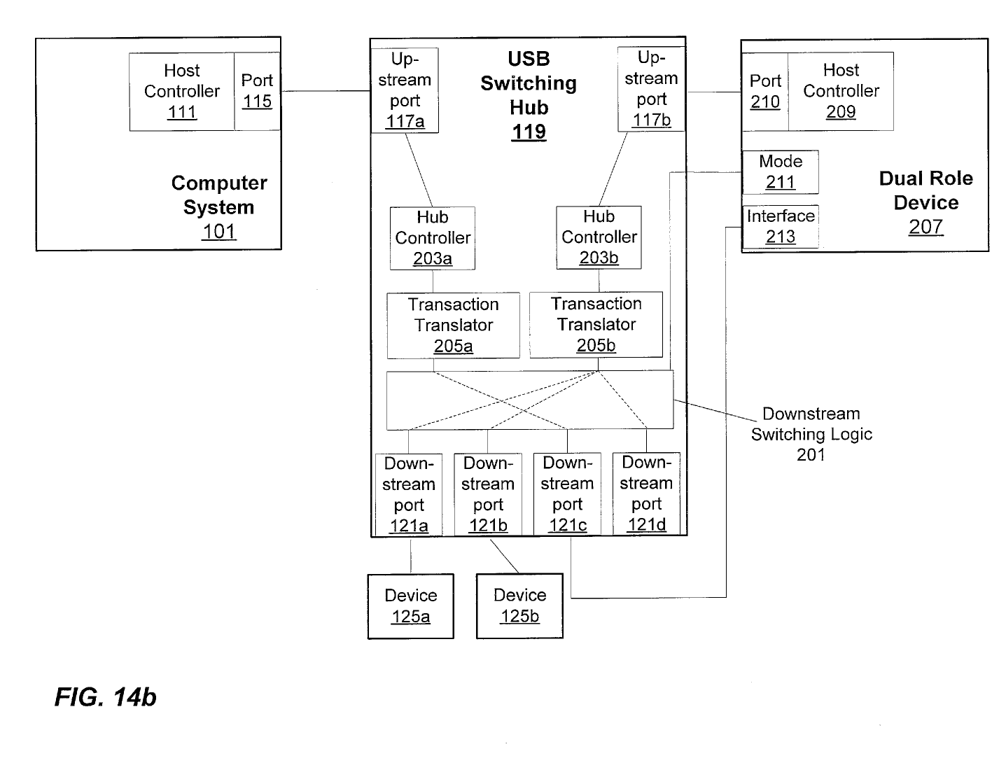

FIGS. 14a and 14b illustrate alternate embodiments of the embodiments shown in FIGS. 4a and 4b of a computer system electronically coupled to multiple peripheral devices. In some embodiments, USB switching hub 119 may act like a switch coupling multiple internal “hubs” that may share one or more downstream ports. For example, each potential communication configuration of the USB switching hub may represent an internal “hub”. In some embodiments, when computer system 101 is accessing peripheral device 125 (e.g., peripheral device 125a) coupled to USB switching hub 119, communications to/from the peripheral device may be processed through a first “hub” comprised of first upstream port 117a, hub controller 203a, transaction translator 205a, and at least a subset of the downstream ports 121. A second “hub” may be comprised of second upstream port 117b, hub controller 203b, transaction translator 205b, and at least a subset of the downstream ports 121. In one communication configuration, computer system 101 may connect to downstream ports 121a and 121c (through the first “hub”), and dual role peripheral device 207 may connect to downstream ports 121b and 121d (through the second “hub”) (as seen in FIG. 14b). Other communication configurations are also contemplated. In some embodiments, communication configuration profiles designating which downstream devices to couple to each upstream port may be hardwired or implemented by software. For example, if implemented by software, communication configuration profiles for each upstream port (and/or upstream device) may be stored on a memory accessible to USB switching hub 119.

In some embodiments, computer system 101 and dual role peripheral device 207 may communicate through USB switching hub 119 simultaneously with separate downstream devices. For example, while computer system 101 communicates with device 125a (e.g., through the first “hub”), dual role peripheral device 207 may communicate with device 125b (e.g., through the second “hub”). In some embodiments, while peripheral device 125a is being accessed through the first “hub”, a different upstream device may not be able to access peripheral device 125a (e.g., dual role peripheral device 207 may not be able to access peripheral device 125a while peripheral device 125a is being used by computer system 101). In some embodiments, a signal (e.g., from an external control block) may trigger downstream switching logic 201 to switch access for a subset of downstream ports 121 (e.g., downstream port 121a and/or 121c) on the first “hub” to the second “hub” (i.e., switch communication configurations). In some embodiments, dual role peripheral device 207 may send a control signal to USB switching hub 119. USB switching hub 119 may then switch communication configurations to connect one or more downstream ports to the dual role peripheral device. For example, when a user presses a button on dual role peripheral device 207 (e.g., a dual role printer), a signal may be sent through mode 211 to downstream switching logic 201 to switch access of device 125a from computer system 101 to dual role peripheral device 207 (i.e., to switch to a second communication configuration as seen in FIG. 14b). Computer system 101 may continue to communicate with downstream port 121c (and/or other downstream ports as determined by the second communication configuration).

In some embodiments, when activity is no longer detected between dual role peripheral device 207 and a downstream port (e.g., if dual role peripheral device 207 is turned off), downstream switching logic 201 may switch access of the downstream port to computer system 101 (i.e., switch to a different communication configuration). In some embodiments, downstream switching logic 201 may switch access of the downstream port to a different upstream device. In some embodiments, instead of detecting inactivity, a signal from dual role peripheral device 207 may signal USB switching hub 119 to switch. Other signals and/or logic may also be used in determining when to switch communication configurations.

In some embodiments, communication configurations may be software implemented. In some embodiments, a microprocessor coupled to or comprised in downstream switching logic 201 may dynamically determine, e.g., using a dynamic communication configuration profile, which downstream ports to electrically couple to each upstream port. For example, the microprocessor may read a stored communication configuration profile and attempt to connect upstream ports to downstream ports according to the communication configuration profile. The communication configuration profiles may be stored on a memory (e.g., an Electronically Erasable Programmable Read-Only Memory (EEPROM)) coupled to USB switching hub 119. In some embodiments, hub controllers 203 on USB switching hub 119 may have access to the communication configuration profiles.

In some embodiments, a priority logic may be used to switch communication configurations. Priority logic, or other logic used to grant access, may be internal or external to USB switching hub 119. In some embodiments, computer system 101 may be given priority over all of downstream ports 121 until an external control signal is sent from dual role peripheral device 207 to switch access of one or more downstream ports 121 to dual role peripheral device 207. In some embodiments, different control signals may be sent to trigger different communication configurations (i.e., to switch access of different downstream ports to dual role peripheral device 207).

In some embodiments, host negotiation logic may be used to determine which communication configuration to use. In some embodiments, a default communication configuration may be used until multiple upstream devices “request” access to the same downstream port. Host negotiation logic may be used to determine which communication configuration to use (i.e., which communication configuration gives a particular upstream port access to the “requested” downstream port).

In some embodiments, a microprocessor in USB switching hub 119 may include a built in algorithm that auto detects downstream peripheral devices and determines how to connect the downstream peripheral devices. For example, instead of assigning a specific downstream port to an upstream port, a communication configuration profile may specify that the upstream port should have access to a digital camera if one is attached. The built in algorithm may auto-detect the digital camera when it is attached to one of the downstream ports and attach it to the appropriate upstream port (i.e., by switching to an appropriate communication configuration).

In some embodiments, when downstream switching logic 201 switches communication configurations, and control of a downstream port is switched from computer system 101 to dual role peripheral device 207, a connection between computer system 101 and respective peripheral device 125 (coupled to the downstream port to be switched) may be terminated by computer system 101. In some embodiments, communications between the downstream port to be switched and computer system 101 may be terminated by USB switching hub 119. Dual role peripheral device 207 may then connect to, enumerate, and communicate with the respective peripheral device 125 coupled to the switched downstream port.

Upstream devices may see downstream ports that they are not configured to attach to as unattached ports (i.e., active, but with no device connected). In some embodiments, if only a predetermined number of downstream ports is ever going to be attached to a particular upstream port (e.g., a number “x” ports), the upstream device may be signaled that the hub only has x ports. For example, if upstream port 117b is only going to be configured to attach to downstream ports 121c and 121d, a device attached to upstream port 117b may be signaled that USB switching hub 119 is only a two port hub.

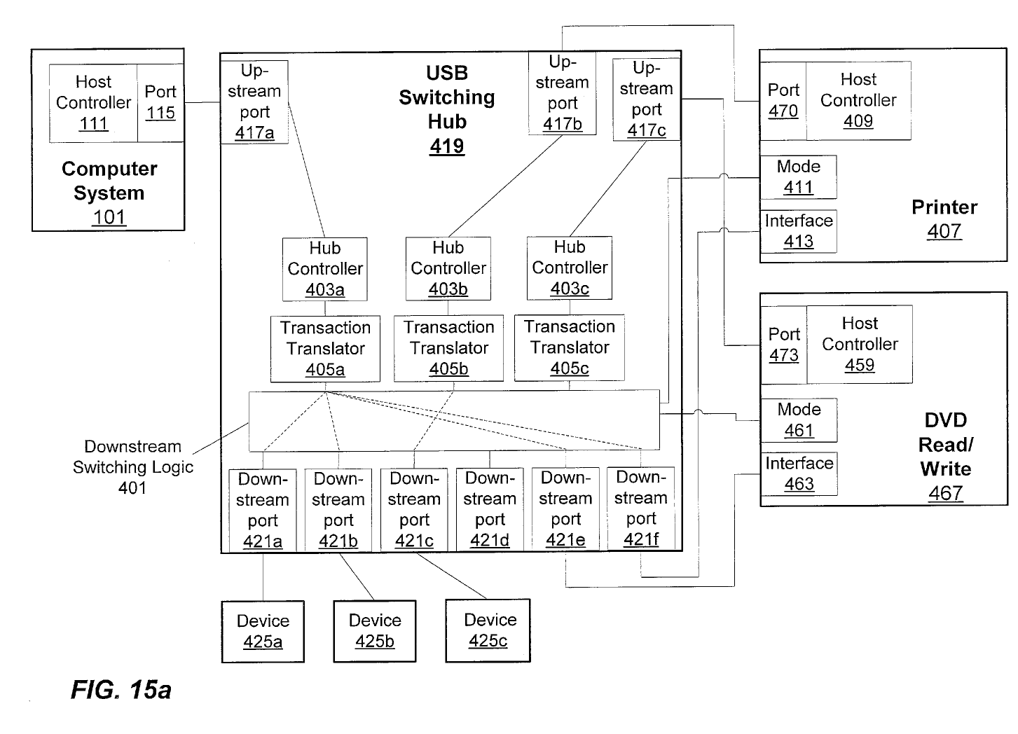

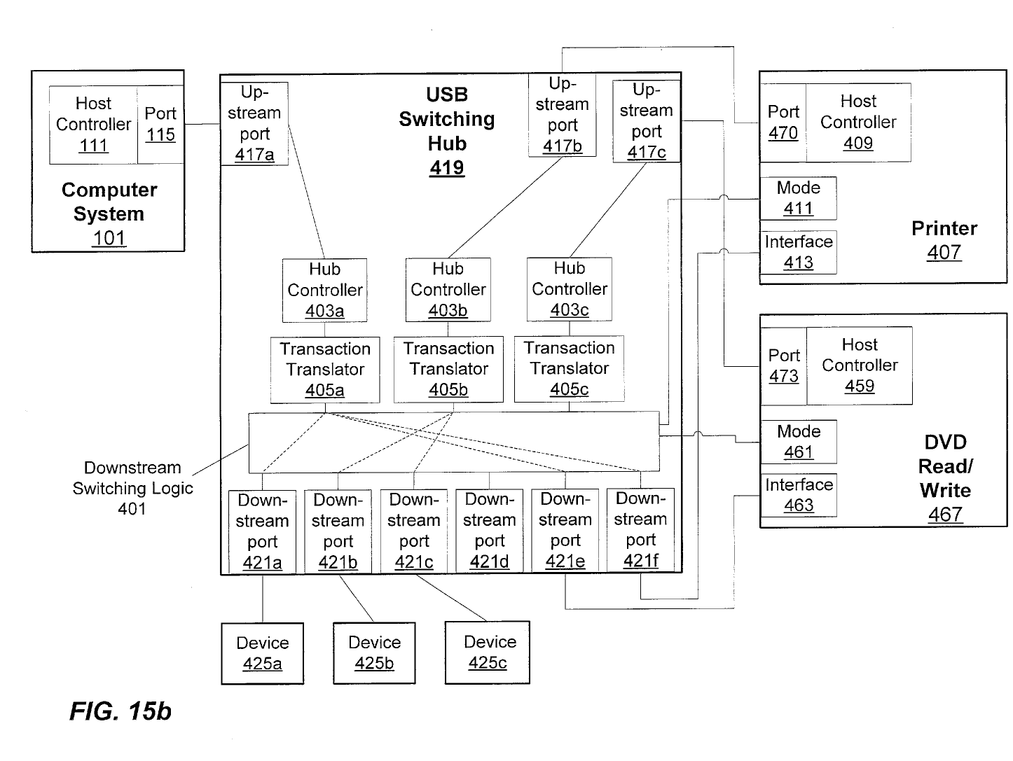

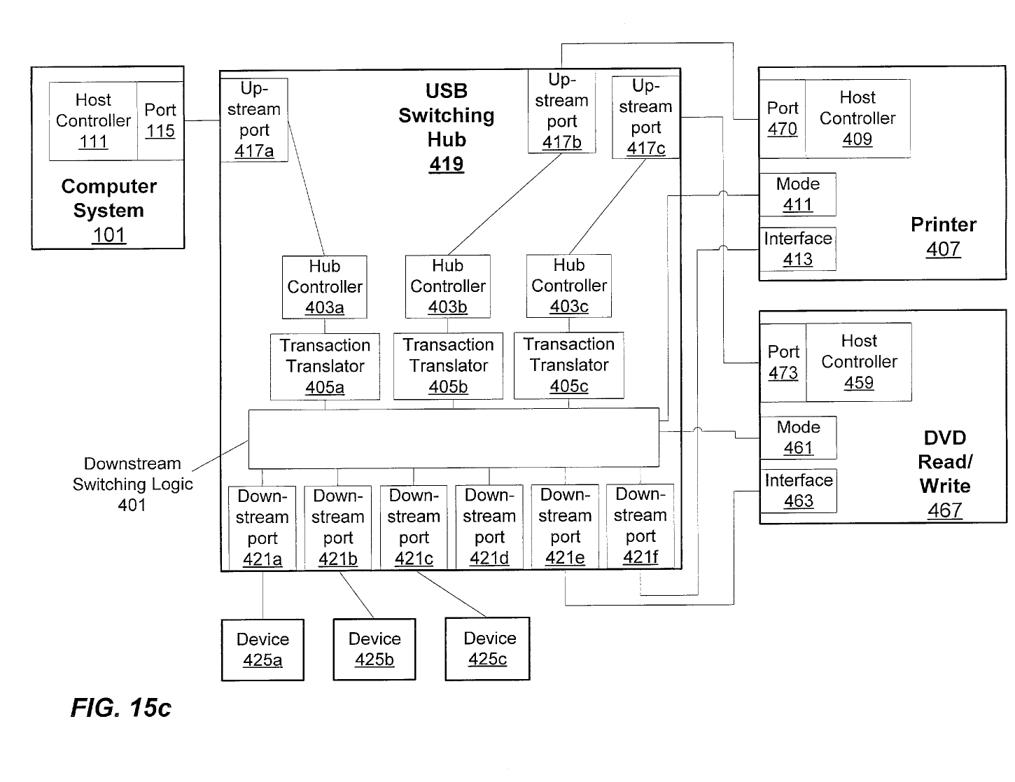

FIGS. 15a, 15b, and 15c illustrate various alternate embodiments of the embodiments shown in FIGS. 5a, 5b, and 5c of a computer system 101 and two dual role peripheral devices coupled to USB switching hub 419. In some embodiments, multiple dual role peripheral devices may be coupled to USB switching hub 419. For example, dual role printer 407 may be coupled to USB switching hub 419 through upstream port 417b and dual role DVD read/write drive 467 may be coupled to USB switching hub 419 through upstream port 417c. Computer system 101 may be coupled to USB switching hub 419 through upstream port 417a. Each of the upstream devices may be coupled to a respective hub controller 403 (403a, 403b and 403c, as shown), a respective transaction translator 405 (405a, 405b, and 405c, as shown), and downstream switching logic 401. Downstream switching logic 401 may configure communications between each of the upstream devices (i.e., computer system 101, dual role printer 407, or dual role DVD read/write drive 467) and at least a subset of the peripheral devices 425.

As seen in FIG. 15a, in one communication configuration profile, the computer system 101 may be connected to downstream ports 421a, 421b, 421e, and 421f. In an embodiment, dual role printer 407 may be configured to access downstream port 421c, and DVD read/write drive 467 may be configured not to access any downstream port 421. Dual role printer 407 may gain access (i.e., have the communication configuration switched to give it access) to downstream port 421b through several different methods. For example, a user may press a button on dual role printer 407. A signal may then be sent through mode 411 to downstream switching logic 401 in USB switching hub 419. Downstream switching logic 401 may switch to the communication configuration seen in FIG. 15b (which allows dual role printer 407 to access downstream port 421b). In some embodiments, if dual role printer 407 is turned off or becomes inactive, downstream switching logic 401 may switch access of downstream port 421b back to computer system 101 (i.e., switch back to the previous communication configuration). As seen in FIG. 15c, in one communication configuration, none of the upstream ports may be allowed to access any of the downstream ports.

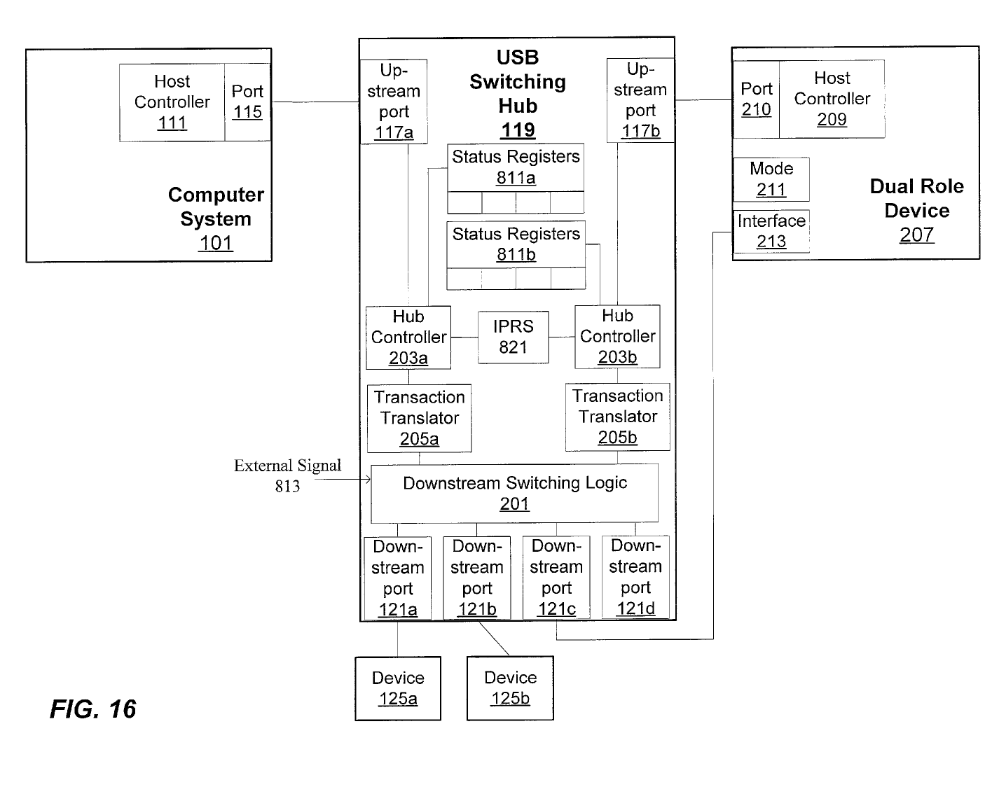

FIG. 16 illustrates an alternate embodiment of the USB switching hub with multiple status registers shown in FIG. 8. In this embodiment, each hub controller (203a and 203b) is coupled to corresponding transaction translator circuitry (205a and 205b, respectively). Translator circuitry 205a and 205b, may be coupled to downstream switching logic 201, which may be electrically coupled to downstream ports 121a, 121b, 121c, and 121d. Switching hub 119 may operate according to the same principles and procedures as described for the embodiment of switching hub 119 shown in FIG. 8.

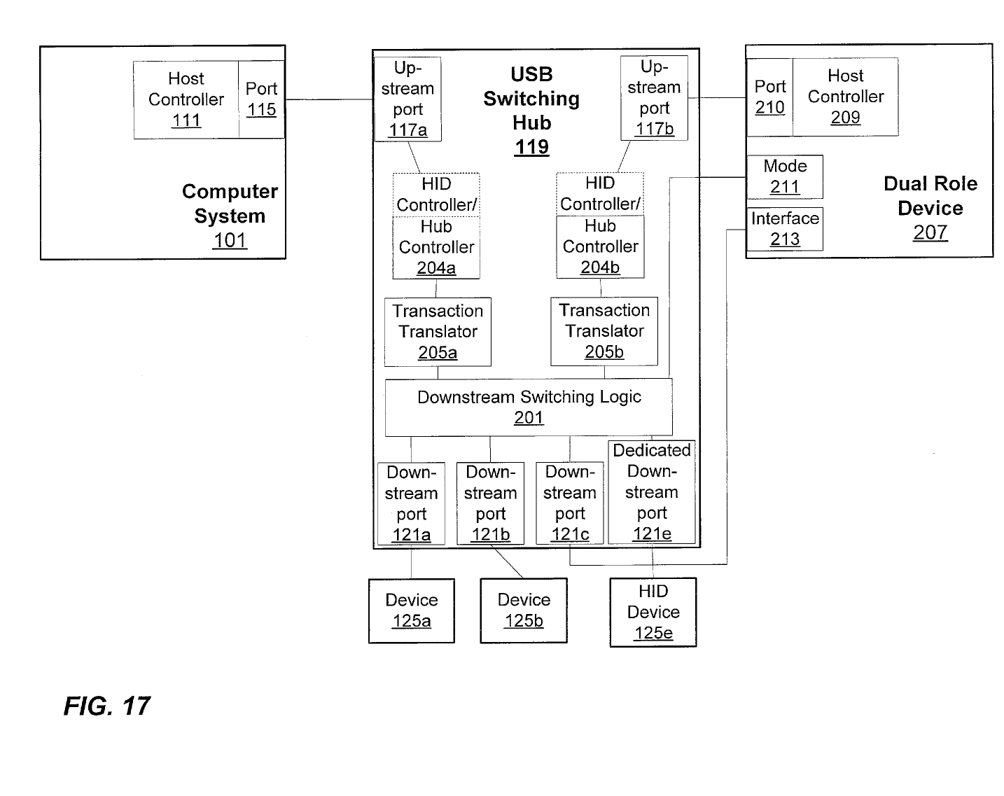

FIG. 17 illustrates another embodiment of the configuration shown in FIG. 13, in which two upstream devices (e.g., computer system 101 and dual role peripheral device 207) are coupled to USB switching hub 119. While in the embodiment of FIG. 13 (and in the embodiments of FIG. 3, FIGS. 4a-4b and FIGS. 14a-14b) the downstream control of USB switching hub 119 is linked with dual role device 207, alternate embodiments may be configured with other switching control means. For example, as illustrated in FIG. 17, switching control of USB switching hub 119 may be performed using a dedicated downstream device, for example HID class device 125e, coupled to a dedicated downstream port, for example dedicated downstream port 121e. Another control mechanism may comprise an additional HID device (not shown) configured at the hub controller level within the hierarchy of the configuration shown in FIG. 17 (for example, at hub controller 203a or 203b). However, operating the additional HID device for controlling the switching of USB switching hub 119 may require custom drivers and a USB-IF class extension to the hub class, which may be covered under a vendor-specific implementation. Mechanisms other than an HID may also be possible with a semi-custom hub driver. Alternatively, a composite device comprising a hub controller and HID controller may be configured to control switching of USB switching hub 119, shown in FIG. 17 as HID controller/HUB controller composite devices 204a and 204b. While FIG. 17 illustrates a variety of configurations associated with possible control mechanisms for controlling switching of USB switching hub 119, various embodiments may include only one of, or any combination of these configurations and/or mechanisms.

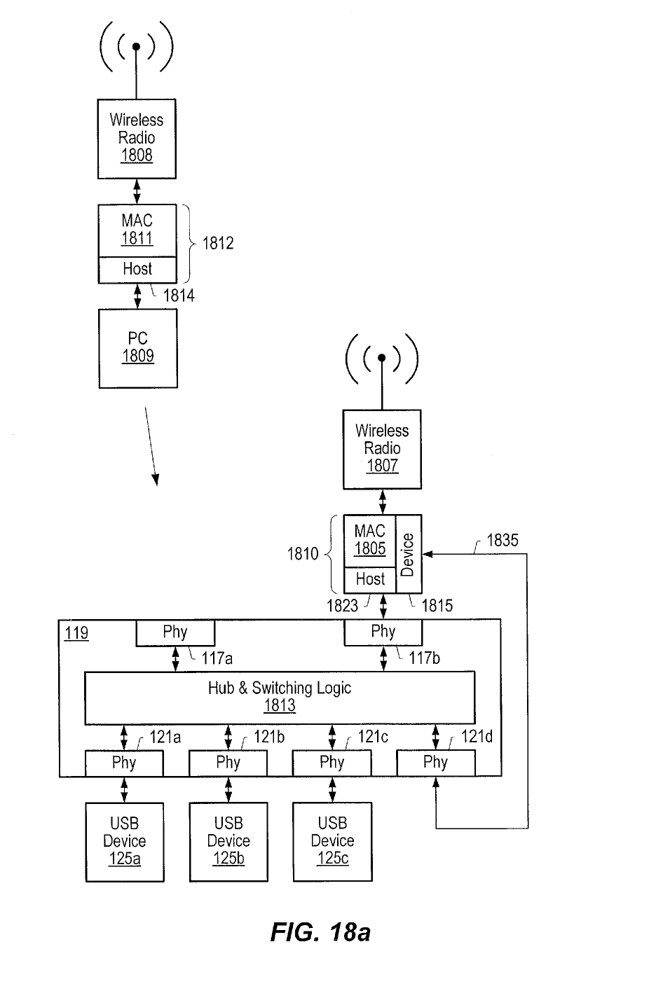

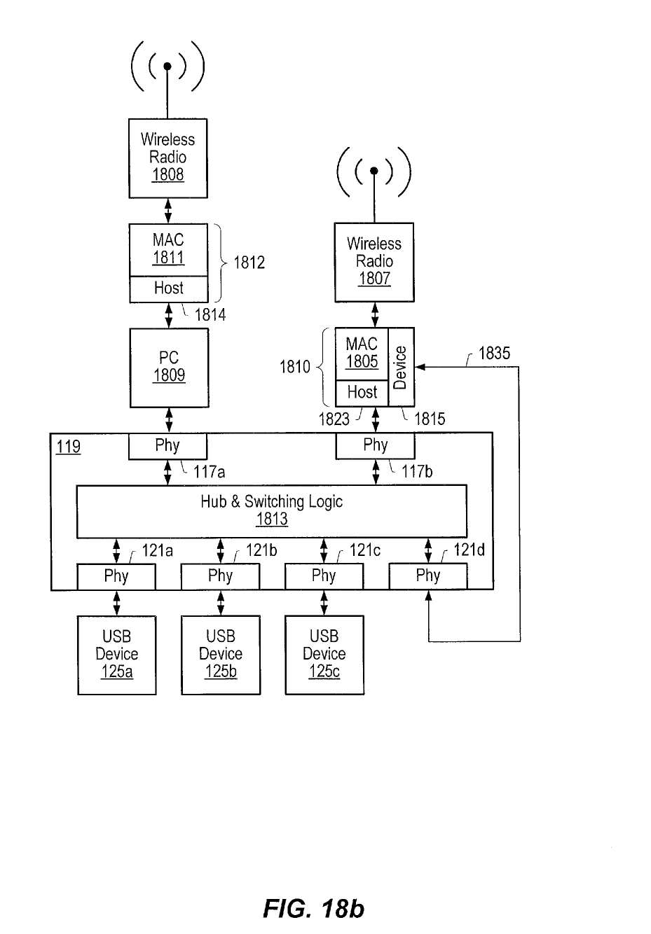

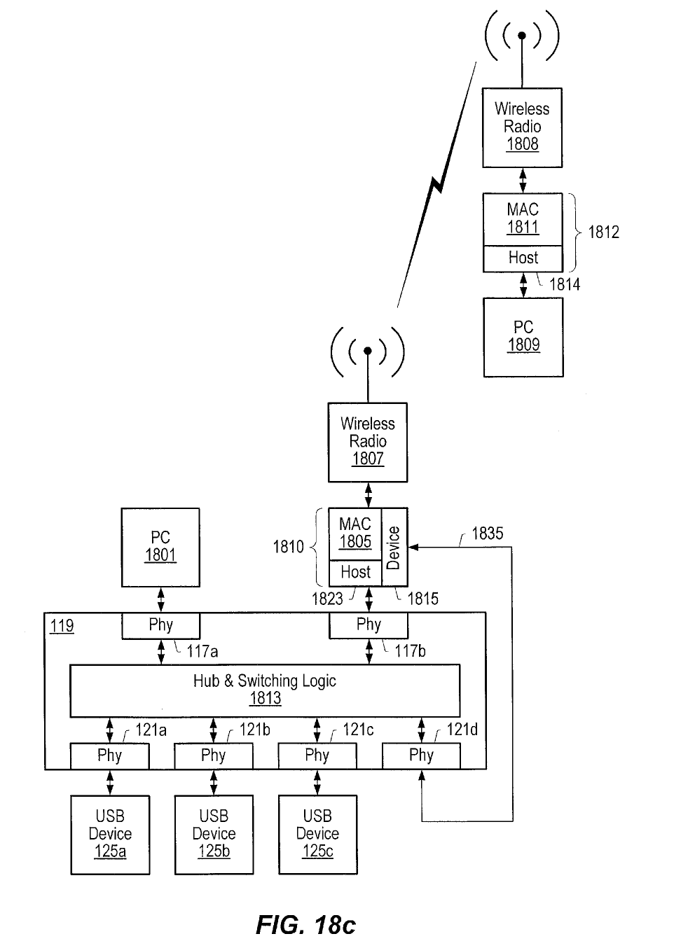

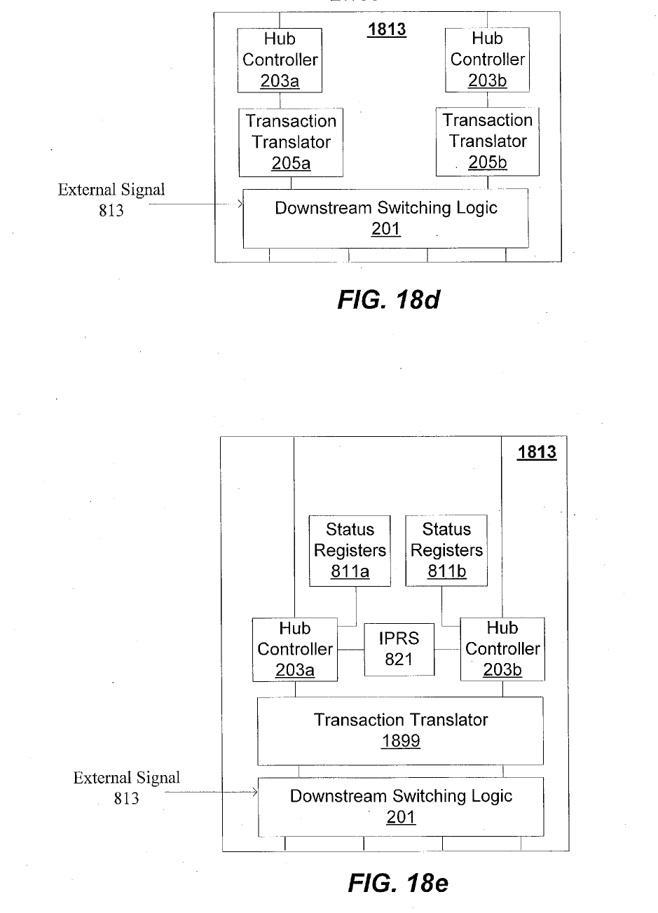

FIGS. 18a, 18b, and 18c illustrate the USB switching hub 119 communicatively coupling to a wireless host 1809, according to an embodiment. FIG. 18c illustrates an embodiment of the USB switching hub 119 communicatively coupled to a wireless host 1809 and a wired host 1801. The USB switching hub 119 may be operable to allow communication between multiple upstream devices (e.g., wired and/or wireless hosts) and downstream devices 125. For example, the USB switching hub 119 may facilitate communication between the wired host 1801, wireless host 1809, and downstream devices 125a, 125b, and 125c attached through downstream ports 121a, 121b, and 121c. In some embodiments, downstream devices 125 may be wireless USB devices. Other numbers and types of wired and/or wireless hosts and downstream devices are also contemplated. The USB switching hub 119 may implement various communication configurations through the hub and switching logic 1813 that allow the wired and/or wireless hosts to access subsets or all of the downstream devices 125a-c. For example, in one communication configuration, the wired host 1801 may access a downstream device (e.g., USB device 125a) substantially simultaneously as the wireless host 1809 is accessing another downstream device (e.g., USB device 125b). In some embodiments, the wired host 1801 and the wireless host 1809 may not substantially simultaneously access the same downstream device.

In some embodiments, wireless host 1809 (e.g., a laptop with a wireless bridge 1812 and transceiver 1808) may communicate with one or more downstream devices 125a-c through the USB switching hub 119. Communications between the downstream devices 125a-c and the wireless host 1809 may pass through wireless bridges 1810, 1812 coupled to wireless transceivers 1807, 1808 (respectively). Wired host 1801 may also communicate with one or more downstream devices 125a-c through the USB switching hub 119. In some embodiments, another wireless host may be communicatively coupled through upstream port 117a instead of wired host 1801.

As seen in FIGS. 18d and 18e, different configurations of the hub and switching logic 1813 may be used. The hub and switching logic 1813 may include hub controllers 203a and 203b (e.g., one for each upstream port) coupled to transaction translators 205a and 205b and downstream switching logic 201. In some embodiments, the order of the transaction translators 205a,b and downstream switching logic 201 may be reversed. Other configurations are also contemplated. FIG. 18e illustrates another embodiment of the hub and switching logic 1813 with status registers 811a and 811b coupled to the hub controllers 203a,b, respectively. IPRS 821 is also shown coupled to the hub controllers 203a,b. In addition, a single transaction translator 1899 is shown (in some embodiments, multiple transaction translators may be used). In some embodiments, the status registers 811a and 811b may be operable to indicate which downstream ports are “disconnected” for the respective communication configuration currently being implemented in the USB switching hub 119. In some embodiments, each upstream device may enumerate the USB switching hub according to its total number of downstream ports (other numbers of ports for enumeration are also contemplated). The downstream switching logic 201 may receive an external signal 813, e.g., to signal the hub and switching logic 1813 to switch communications for a subset of downstream ports 125a-c.

In some embodiments, wireless USB hosts and devices may use association to implement secure communications. Association may include making an initial connection between a host (e.g., host 1809/wireless bridge 1812) and a device (e.g., wireless bridge 1810), verifying the host and the device to each other, and deriving an initial encryption key for future communications. In some embodiments, a wireless host 1809 and the device (e.g., wireless bridge 1810) may use a temporary physical connection (e.g., by both physically coupling to the USB switching hub 119 and/or connecting through a cable as seen in FIG. 18b) to make the initial connection, verification, and key derivation. Wireless hosts and devices may use a symmetric encryption algorithm such as Wireless USB Advanced Encryption Standard (AES)-128 Counter with Cipher Block Chaining Message Authentication Code (CBC-MAC) (CCM) or Wireless USB AES-128 Counter with CBC-MAC (CCM). Other encryption methods such as public key encryption may also be used.

In some embodiments, the wireless bridge 1810 may include a downstream device port 1815 which may be coupled to a downstream port 121d of the USB switching hub 119. As seen in FIG. 18b, the wireless host 1809/wireless bridge 1812 may be temporarily physically coupled to the first upstream port (e.g., PHY 117a) to complete association with the wireless bridge 1810 coupled as a downstream device through downstream port 121d. In various embodiments, either or both the host 1809 and wireless bridge 1812 may be temporarily physically coupled to the first upstream port 117a as the host for association (e.g., wireless bridge 1812 may be coupled to first upstream port 117a to perform association with wireless bridge 1810 without being coupled to wireless host 1809 during association). Host 1809/wireless bridge 1812 and wireless bridge 1810 may exchange an encryption key (e.g., a symmetric key) through connection 1835 (e.g., host 1809/wireless bridge 1812 may send an encryption key to wireless bridge 1810 or wireless bridge 1810 may send an encryption key to host 1809/wireless bridge 1812). As used herein, the term “exchange” may be used to refer to a one-way transfer. As seen in FIG. 18c, the host 1809/wireless bridge 1812 may be physically disconnected from the USB switching hub 119 and the host 1809/wireless bridge 1812 and wireless bridge 1810 may use the encryption key for future wireless communications. In some embodiments, instead of being physically coupled to the USB switching hub 119, a code may be entered into the host 1809/wireless bridge 1812 (e.g., a code from the wireless bridge 1810). In some embodiments, the code may be read off of the wireless bridge 1810 and entered through a keypad into the host 1809/wireless bridge 1812. The host 1809/wireless bridge 1812 may generate an encryption key using the code (the wireless bridge 1810 may have generated the same encryption key using the code and a pre-established method). Other methods of association and key exchange are also contemplated. The wireless bridge 1810 may electronically attach to the wireless bridge 1812 by sending the host 1809/wireless bridge 1812 a message and then proceeding through an authenticating process involving their unique identifications (IDs) and the encryption key. Host software on host 1809/wireless bridge 1812 may be notified of the “attached” wireless bridge 1810 after the association process is completed. In some embodiments, downstream devices 125 may include one or more wireless downstream devices that may also proceed with association with the wireless bridge 1810 or wireless bridge 1812 (although, in some embodiments, the downstream devices 125 may not separately associate but may communicate through the wireless bridge 1810).

In some embodiments, wireless hosts and devices may use the exchanged keys to authenticate each other during future connection requests (e.g., see the Wireless Universal Serial Bus Specification, Revision 1.0). The keys may also be used to encrypt and decrypt future transmissions. The device (e.g., wireless bridge 1810) and the host (e.g., host 1809/wireless bridge 1812) may establish a connection context (CC) with a unique host ID (CHID), a unique device ID (CDID), and connection key (CK) (a symmetric encryption key). In some embodiments, the CC may be created by a host device and sent to a device on the first connection (and/or by using an out-of-band method). The CK may be unique for each device for which the host is connected. The CK may be used to derive a pair-wise temporal key (PTK) through four-way handshakes (between the host and the device) for use by the host and device in encrypting/decrypting communications. During four-way handshakes, the host and the device may exchange a random nonce and an identifier of the key they are using. The device and host may then perform key generation using the random nonces to generate a message integrity code (MIC) that are also exchanged. If the device and host verify the received MIC (based on the CK), the device and host may know that they are communicating with a device/host that has the previously established key and therefore can be trusted. The device and host may also use the exchanged nonces to generate initial session keys (which may be used as PTKs for encryption/decryption of future communications between the host and the device). In some embodiments, the wireless bridge 1810 may handle encryption/decryption for communications from the downstream devices 125 (e.g., using one PTK for communications from the devices 125). In some embodiments, the separate keys may be used for communications from each device 125.

In some embodiments, a media access controller (MAC) 1805 may be included (as part of a data link layer for transporting data packets) on the wireless bridge 1810 to, for example, control access to the transceiver 1807. The MAC 1811 on wireless bridge 1812 may, for example, control access to the transceiver 1808. The data link layer may also include a logical link control (LLC) for multiplexing protocols and providing flow control over the transceivers 1807, 1808. MAC 1805 may be coupled to the USB switching hub 119 through host interface 1823 and upstream port 117b. MAC 1811 may be coupled to the host 1809 through host interface 1814.

In some embodiments, MACs 1805 and 1811 may insert source and destination addresses into transmitted frames to enable the receiving MAC to determine which frames are being sent to its device. These addresses may include MAC addresses (unique identifiers for the communicating devices). MACs 1805 and 1811 may also recognize the beginning and ending of frames received and transmitted and may detect transmission errors. Transmissions between wireless transceivers 1807 and 1808 may include token, data, and handshake packets (or packets containing a combination of these types). Other packet configurations are also contemplated. In some embodiments, the MACs 1805 and 1811 may work with the data link layer in their respective wireless bridges to encode/decode bit streams into/out of data packets and provide transmission protocol knowledge and management.

In some embodiments, wireless host 1809 may also communicate with other wireless devices in addition to the wired devices coupled to the USB switching hub 119. Wireless host 1809 may also communicate with other wired peripheral devices coupled to a device wire adapter.

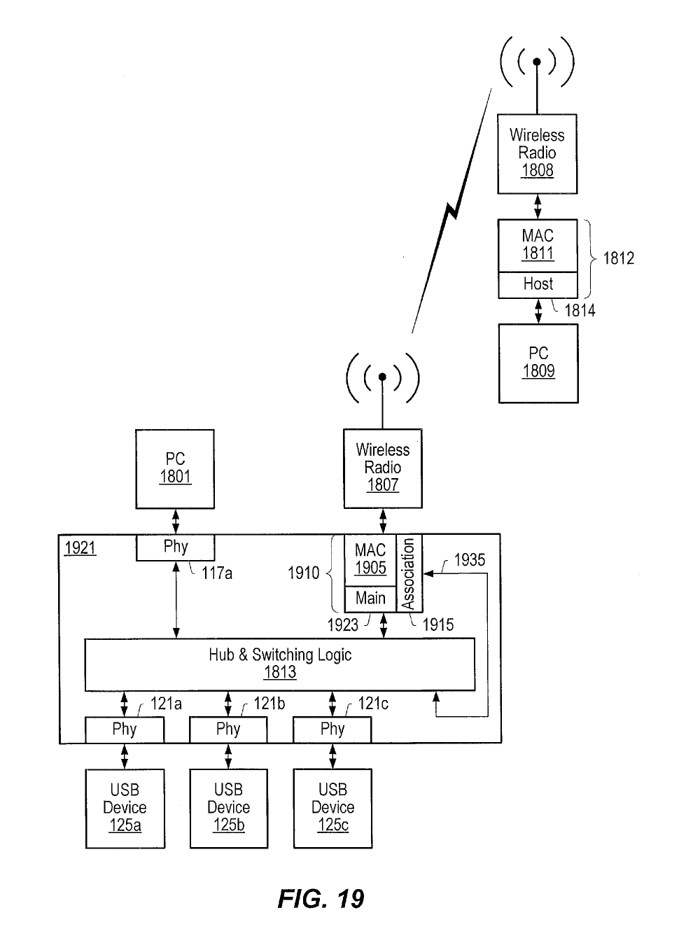

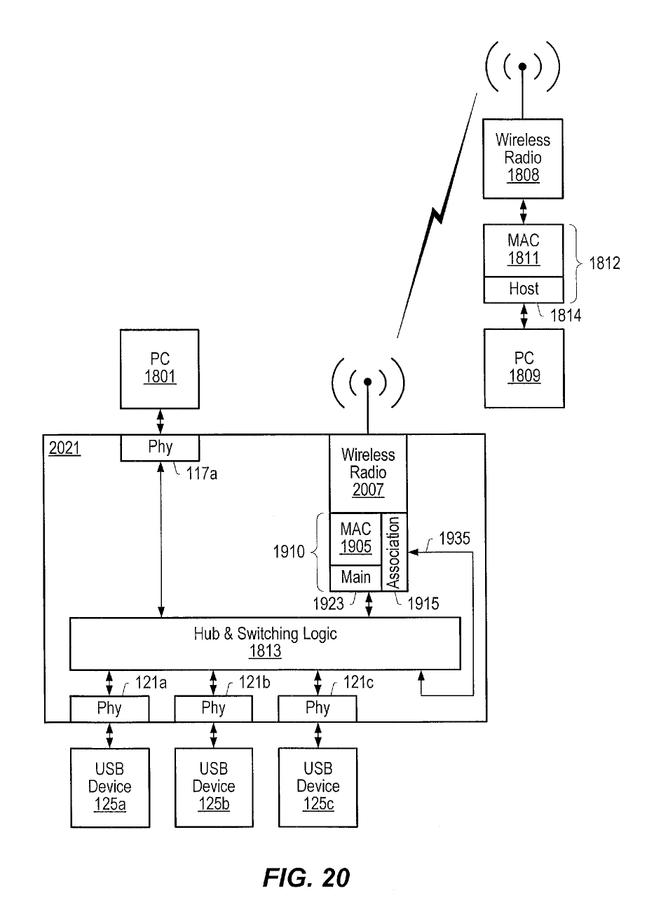

FIG. 19 illustrates an embodiment of the USB switching hub 1921 with an internal wireless bridge 1910. As seen in FIG. 19, the wireless bridge 1910 with MAC 1905 may be internal to the USB switching hub 1921. In this embodiment, the downstream device port 1915 on the wireless bridge may also be internal and may be internally coupled to a downstream port of the hub and switching logic 1813. The internal connection 1935 may be used during the initial association with the wireless host 1809 (e.g., when the wireless host 1809 is initially physically coupled to upstream port 117a of the USB switching hub 1921). The MAC 1905 may communicate with the downstream devices 125 through main interface 1923 and hub and switching logic 1813. FIG. 20 illustrates an embodiment of the USB switching hub 2021 with an internal wireless bridge 1910 and internal transceiver 2007.

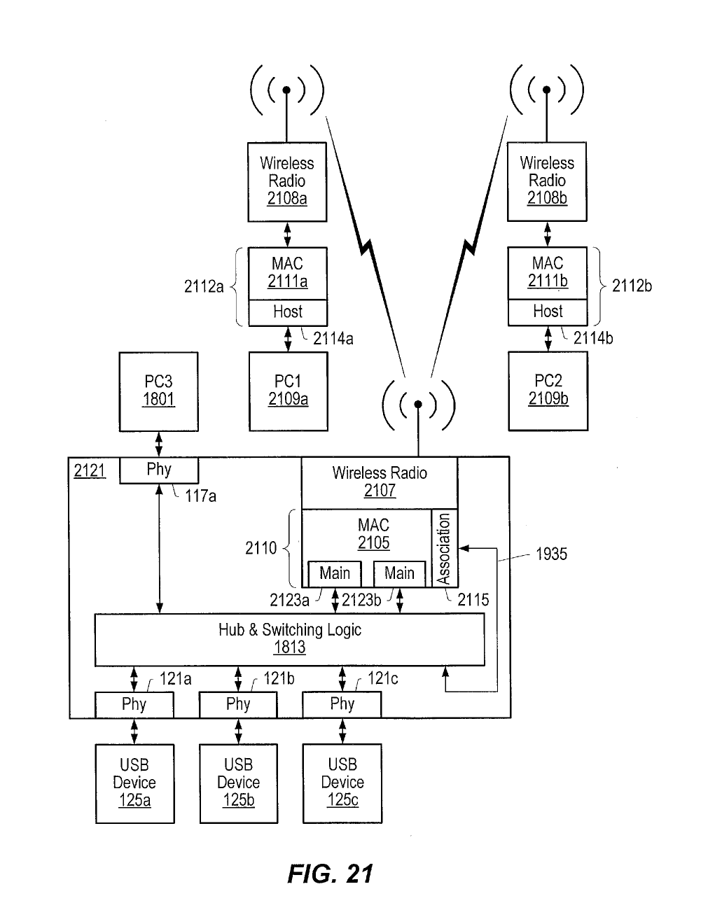

FIG. 21 illustrates an embodiment of the USB switching hub 2121 coupled to a plurality of wireless hosts 2109a, 2109b. Multiple wireless hosts 2109a, 2109b may be coupled to the USB switching hub 2121 through transceiver 2107 and their respective transceivers 2108a, 2108b to share downstream devices 125. The host 2109a and host 2109b may each be coupled separately to upstream port 117a to exchange an encryption key with wireless bridge 2110. Wireless bridge 2110 may be coupled to two or more upstream ports 2123a and 2123b of the USB switching hub 2121. The encryption keys may be exchanged through connection 1935 with downstream device port 2115 on the wireless bridge 2110. The wireless bridge 2110 may use each respective encryption key to communicate with the wireless hosts 2109a and 2109b when the wireless hosts 2109a and 2109b are not physically attached to the USB switching hub 2121. The MACs 2111a and 2111b may coordinate with MAC 2105 to communicate through transceivers 2107, 2108a, and 2108b. Wireless bridge 2110 may facilitate communications between the wireless hosts 2109a,b and the downstream devices 125 through upstream ports 2123a and 2123b. In some embodiments, each wireless host may communicate with a separate wireless bridge coupled to the USB switching hub 2121 (e.g., each separate wireless bridge coupled to a separate upstream port).

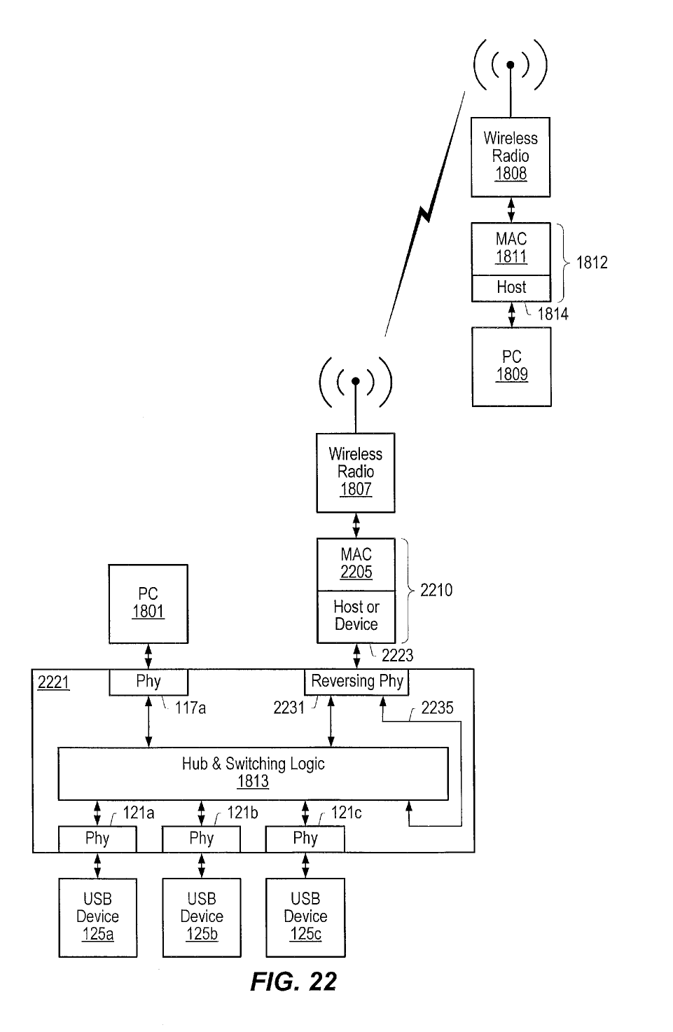

FIG. 22 illustrates an embodiment of the USB switching hub 2221 with a reversible port 2231. The USB switching hub 2221 reversible port 2231 may include switching logic operable to switch upstream and downstream logic to allow the reversible port 2231 to act as a downstream port or an upstream port when communicating through interface 2223 (e.g., see U.S. patent application Ser. No. 11/412,431 incorporated by reference above). The reversible port 2231 may perform as a downstream port to connect wireless bridge 2210 to the USB switching hub 2221 as a downstream device when the wireless host 1809 is physically coupled to the USB switching hub 2221 for association purposes (e.g., to exchange keys with wireless bridge 2210 through connection 2235). The reversible port 2231 may then switch over to operating as an upstream port for the wireless bridge 2210 when the wireless host 1809/wireless bridge 1812 is not physically coupled to the USB switching hub 2221 but is instead communicating with the downstream devices 125a, 125b, and 125c through the USB switching hub 2221 in a wireless fashion. Input directing a switch may be received from any of a variety of sources (e.g., logic within the USB switching hub 2221, wireless bridge 2210, a user, etc.), and may set or invoke a switching condition, which may then be detected by the USB switching hub 2221. In some embodiments, the reversible port 2231 may coordinate with the hub and switching logic 1813 to implement switching upstream and downstream logic as needed.

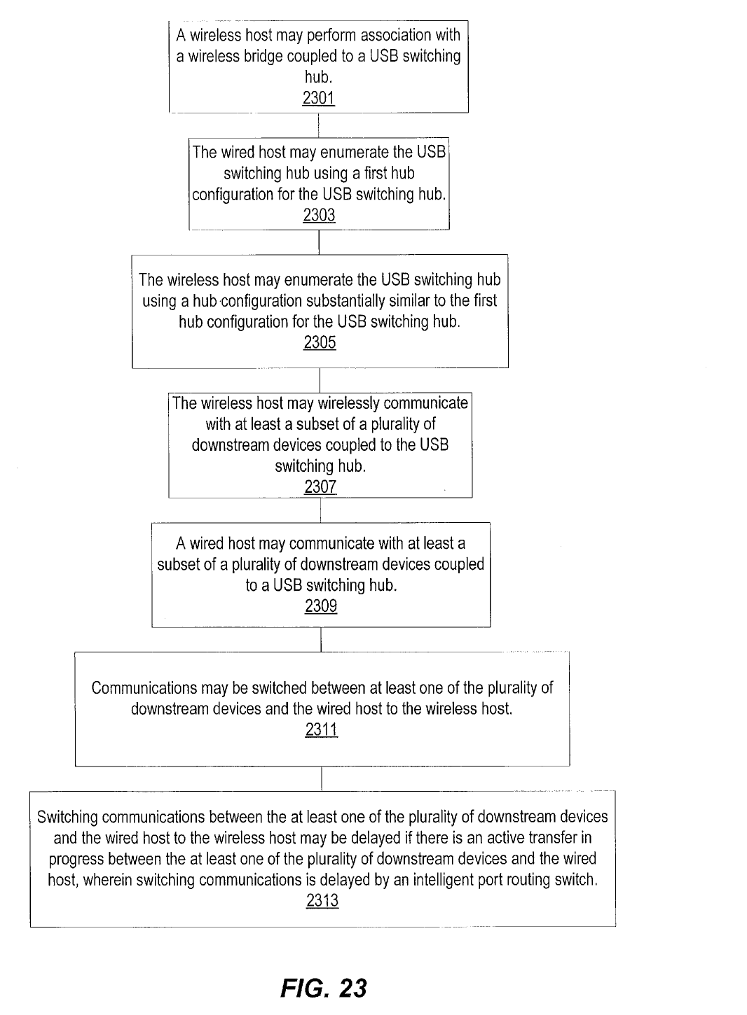

FIG. 23 illustrates a method of using the USB switching hub to support a wireless host, according to an embodiment. Various embodiments of the USB switching hub supporting a wireless host may be seen, for example, in FIGS. 18c and 19-22. The method shown in FIG. 23 is described below with respect to FIGS. 18a-c, but it is to be understood that the method is also applicable to other embodiments described above. It should be noted that in various embodiments of the methods described below, one or more of the elements described may be performed concurrently, in a different order than shown, or may be omitted entirely. Other additional elements may also be performed as desired.

At 2301, a wireless host 1809 may perform association with a wireless bridge 1810 coupled to the USB switching hub 119. The wireless host 1809 and wireless bridge 1810 performing association may each be coupled to a separate upstream port of the USB switching hub 119 (e.g., see FIG. 18b). After association, the wireless host 1809 may be removed from the upstream port 117a of the USB switching hub 119, and in some embodiments, a wired host 1801 may be coupled to the upstream port 117a.

At 2303, the wired host 1801 may enumerate the USB switching hub 119 using a first hub configuration for the USB switching hub 119. In some embodiments, the downstream devices 125 coupled to the USB switching hub 119 may be enumerated by the wired host 1801 when the USB switching hub 119 is enumerated.

At 2305, the wireless host 1809 may enumerate the USB switching hub 119 using a hub configuration substantially similar to the first hub configuration for the USB switching hub 119. In some embodiments, the downstream devices 125 coupled to the USB switching hub 119 may be enumerated by the wireless host 1809 when the USB switching hub 119 is enumerated.

At 2307, the wireless host 1809 may wirelessly communicate with at least a subset of a plurality of downstream devices 125 coupled to the USB switching hub 119 through the wireless bridge 1810.

At 2309, a wired host 1801 may communicate with at least a subset of a plurality of downstream devices 125 coupled to a USB switching hub 119. In some embodiments, the wireless host 1809 and the wired host 1801 may communicate substantially simultaneously with separate downstream devices 125 coupled to the USB switching hub 119.

At 2311, communications may be switched between at least one of the plurality of downstream devices 125 and the wired host 1801 to the wireless host 1809. In some embodiments, the USB switching hub 119 may not be re-enumerated when communications are switched. In some embodiments, communications may be switched between at least one of the plurality of downstream devices 125 and the wireless host 1809 to the wired host 1801.

At 2313, switching communications between the at least one of the plurality of downstream devices 125 and the wired host 1801 to the wireless host 1809 may be delayed if there is an active transfer in progress between the at least one of the plurality of downstream devices 125 and the wired host 1801, wherein switching communications is delayed by an intelligent port routing switch (e.g., see IPRS 821 in FIG. 18e). In some embodiments, communications may be similarly delayed when switching communications between the plurality of downstream devices 125 and the wireless host 1809 to the wired host 1801 if there is an active transfer in progress between the at least one of the plurality of downstream devices 125 and the wireless host 1809.

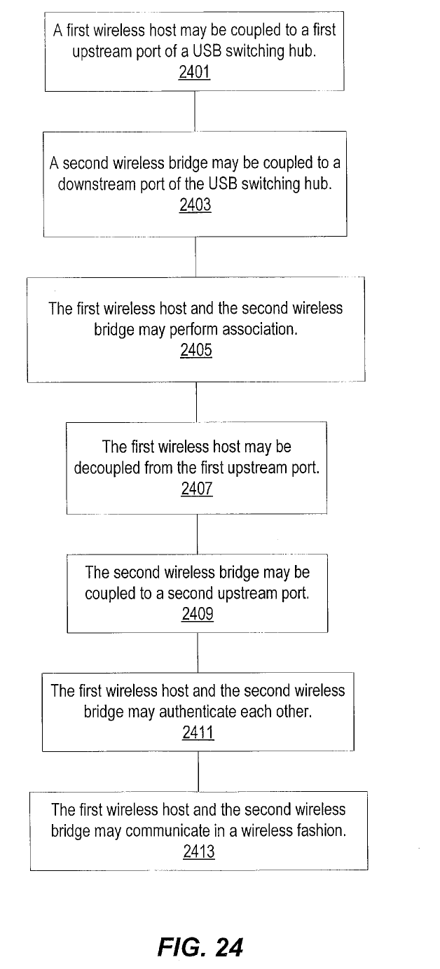

FIG. 24 illustrates a method for using the USB switching hub for associating a wireless host, according to an embodiment. The method shown in FIG. 24 is described below with respect to FIGS. 18a-c, but it is to be understood that the method is also applicable to other embodiments described above. It should be noted that in various embodiments of the methods described below, one or more of the elements described may be performed concurrently, in a different order than shown, or may be omitted entirely. Other additional elements may also be performed as desired.

At 2401, a first wireless host 1809 (which may include host 1809 and/or associated wireless bridge 1812) may be coupled to a first upstream port 117a of a USB switching hub 119. One or more downstream devices 125 may be coupled to downstream ports 121 of the USB switching hub 119.

At 2403, a second wireless bridge 1810 may be coupled to a downstream port 121d of the USB switching hub 119.

At 2405, the first wireless host 1809 and the second wireless bridge 1810 may perform association.

At 2407, the first wireless host 1809 may be decoupled from the first upstream port 117a. For example, see FIG. 18c in which wireless host 1809 has been decoupled from the USB switching hub 119 and wired host 1801 has been coupled to the upstream port 117a.

At 2409, the second wireless bridge 1810 may be coupled to a second upstream port 117b. The second wireless bridge 1810 may have been coupled to the second upstream port 117b prior to association.

At 2411, the first wireless host 1809 and the second wireless bridge 1810 may authenticate each other.

At 2413, the first wireless host 1809 and the second wireless bridge 1810 may communicate in a wireless fashion. The wireless bridge 1812 coupled to the wireless host 1809 may cooperate with wireless bridge 1810 coupled to USB switching hub 119 to allow communications between the wireless host 1809 and the downstream devices 125 coupled to the USB switching hub 119.

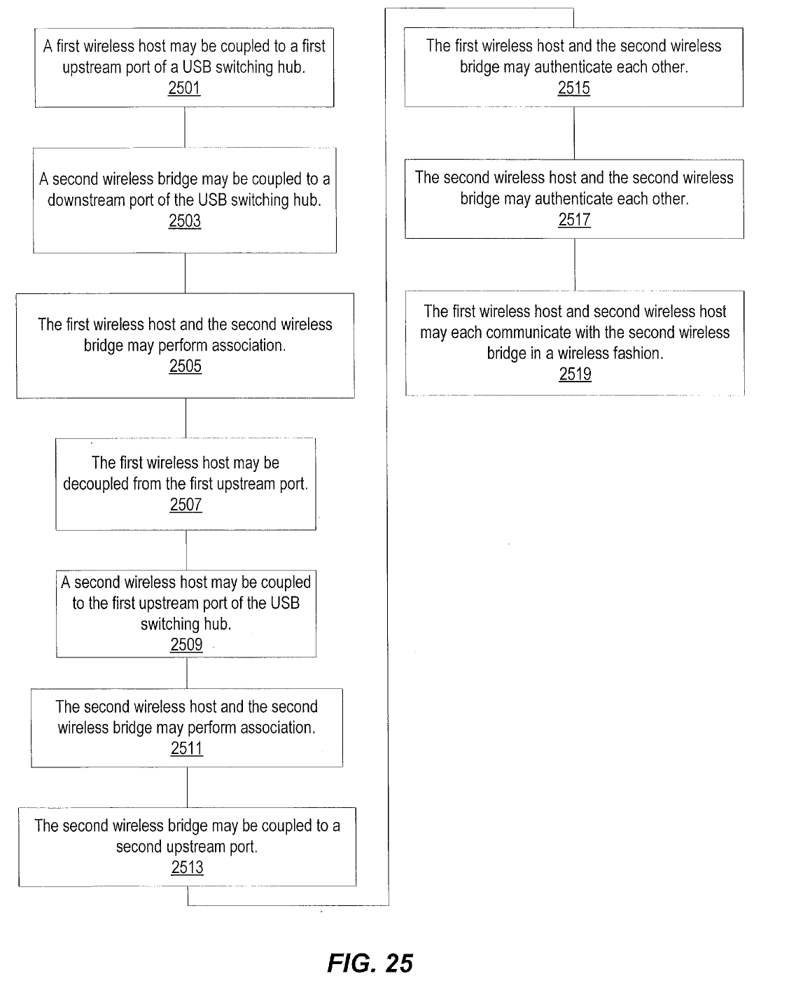

FIG. 25 illustrates a method for using the USB switching hub for supporting multiple wireless hosts, according to an embodiment. The method shown in FIG. 25 is described below with respect to FIG. 21, but it is to be understood that the method is also applicable to other embodiments described above. It should be noted that in various embodiments of the methods described below, one or more of the elements described may be performed concurrently, in a different order than shown, or may be omitted entirely. Other additional elements may also be performed as desired.

At 2501, a first wireless host 2109a may be coupled to a first upstream port 117a of a USB switching hub 2121. One or more downstream devices 125 may be coupled to downstream ports 121 of the USB switching hub 2121.

At 2503, a second wireless bridge 2110 may be coupled to a downstream port of the USB switching hub 2121. In some embodiments, the downstream port may be internal to the hub (e.g., the wireless bridge 2110 may internally couple to the hub and switching logic 1813).

At 2505, the first wireless host 2109a (and/or wireless bridge 2112a) and the second wireless bridge 2110 may perform association.

At 2507, the first wireless host 2109a (and/or wireless bridge 2112a) may be decoupled from the first upstream port 117a.

At 2509, a second wireless host 2109b (and/or wireless bridge 2112b) may be coupled to the first upstream port 117a of the USB switching hub 2121.

At 2511, the second wireless host 2109b (and/or wireless bridge 2112b) and the second wireless bridge 2110 may perform association. In some embodiments, the second wireless bridge 2110 may use a separate encryption key when communicating with the first wireless host 2109a than when communicating with the second wireless host 2109b. The second wireless bridge 2110 may use different identifiers in communications for each of the first and second wireless hosts 2109a,b.

At 2513, the second wireless bridge 2110 may be coupled to a second upstream port(s). The second wireless bridge may have been coupled to the second upstream port(s) prior to association. In some embodiments, the second wireless bridge 2110 may be coupled to one upstream port per wireless host. For example, as seen in FIG. 21, wireless bridge 2110 is coupled through upstream port 2123a (for communications between wireless host 2109a and at least a subset of downstream devices 125) and upstream port 2123b (for communications between wireless host 2109b and at least a subset of downstream devices 125). In some embodiments, a separate wireless bridge may be used in the USB switching hub for each wireless host.

At 2515, the first wireless host 2109a and the second wireless bridge 2110 may authenticate each other.

At 2517, the second wireless host 2109b and the second wireless bridge 2110 may authenticate each other.

At 2519, the first wireless host 2109a and second wireless host 2109b may each communicate with the second wireless bridge 2110 in a wireless fashion. The first wireless host 2109a and the second wireless host 2109b may communicate with downstream devices 125 coupled to the USB switching hub 2121 at substantially the same time (e.g., through two respective upstream ports 2123a,b coupled to second wireless bridge 2110). The second wireless bridge 2110 may coordinate communications to and from wireless bridges 2112a and 2112b to allow communication between the wireless hosts 2109a,b and the downstream devices 125. For example, unique identifiers may be used to identify communications between each wireless host and its respective downstream device(s). In some embodiments, first wireless host 2109a and second wireless host 2109b may communicate with separate wireless bridges each coupled to a different upstream port of the USB switching hub 2121.

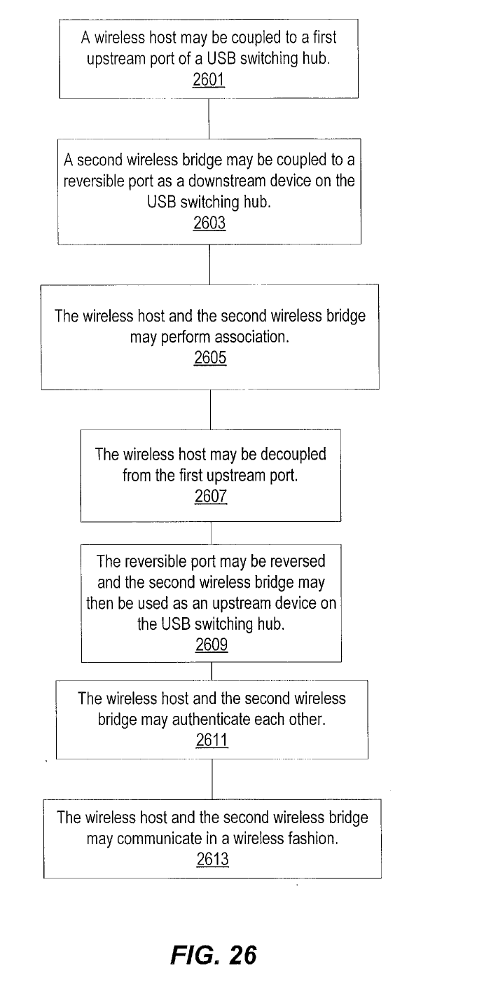

FIG. 26 illustrates a method for using the USB switching hub (e.g., see USB switching hub 2221 in FIG. 22) with a reversible port 2231 to support a wireless bridge 2210 as a downstream device during association and an upstream device during regular communications, according to an embodiment. It should be noted that in various embodiments of the methods described below, one or more of the elements described may be performed concurrently, in a different order than shown, or may be omitted entirely. Other additional elements may also be performed as desired.

At 2601, a wireless host 1809 may be coupled to a first upstream port 117a of a USB switching hub 2221.

At 2603, a second wireless bridge 2210 may be coupled to a reversible port 2231 as a downstream device on the USB switching hub 2221. In some embodiments, the reversible port 2231 may be signaled to perform as a downstream port. Logic in the USB switching hub 2221 may be manipulated to support the reversible port 2231 as a downstream port.

At 2605, the wireless host 1809 and the second wireless bridge 2210 may perform association.

At 2607, the wireless host 1809 may be decoupled from the first upstream port 117a.

At 2609, the reversible port 2231 may be reversed (e.g., through a signal sent to the reversible port 2231 and/or USB switching hub 2221) and the second wireless bridge 2210 may then be used as an upstream device on the USB switching hub 2210.

At 2611, the wireless host 1809 and the second wireless bridge 2210 may authenticate each other.

At 2613, the wireless host 1809 and the second wireless bridge 2210 may communicate in a wireless fashion. The wireless bridge 1812 and second wireless bridge 2210 may coordinate to allow communications between the wireless host 1809 and the downstream devices 125 coupled to the USB switching hub 2221.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An apparatus, comprising:
a Universal Serial Bus (USB) switching hub, comprising:
a plurality of upstream ports; and
a plurality of downstream ports;
wherein a first upstream port of the plurality of upstream ports is operable to couple to a first host;
wherein a second upstream port of the plurality of upstream ports is operable to communicate with a wireless host;
wherein the at least a subset of downstream ports of the plurality of downstream ports are accessible to the first upstream port and the second upstream port.

2. The apparatus of claim 1, wherein the USB switching hub further comprises:
downstream switching logic coupled between the plurality of upstream ports and the plurality of downstream ports;
wherein the plurality of downstream ports consists of N downstream ports;
wherein the downstream switching logic is configured to electronically switch communications between:
a) a downstream port of the plurality of downstream ports and a first upstream port of the plurality of upstream ports to
b) the downstream port of the plurality of downstream ports and a second upstream port of the plurality of upstream ports;
wherein the USB switching hub is configured to be enumerated with a substantially similar hub configuration through each of the plurality of upstream ports;
wherein the hub configuration includes N downstream ports.

3. The apparatus of claim 1, wherein the USB switching hub is operable to switch communications without upstream devices coupled to the first upstream port and the second upstream being required to re-enumerate the USB switching hub.

4. The apparatus of claim 1, wherein the second upstream port is coupled to a media access controller and a transceiver.

5. The apparatus of claim 1, further comprising a wireless bridge coupled to a downstream port of the USB switching hub for association with the wireless host when the wireless host is coupled to the first upstream port.

6. The apparatus of claim 5, wherein the wireless bridge is internal to the USB switching hub.

7. The apparatus of claim 6, wherein the wireless bridge and the transceiver are internal to the USB switching hub.

8. The apparatus of claim 1, wherein the wireless host includes a media access controller and a transceiver.

9. The apparatus of claim 1, wherein the second port comprises switching logic operable to switch upstream logic and downstream logic with respect to the second port and at least a subset of the plurality of downstream ports, respectively.

10. The apparatus of claim 1, wherein the second upstream port is operable to communicatively couple to a plurality of wireless hosts.

11. A method, comprising:
communicating between a wired host and at least a subset of a plurality of downstream devices coupled to a Universal Serial Bus (USB) switching hub; and
wirelessly communicating between a wireless host and at least a subset of a plurality of downstream devices coupled to the USB switching hub.

12. The method of claim 11, further comprising associating a wireless host with a wireless bridge coupled to a USB switching hub.

13. The method of claim 12, wherein associating the wireless host comprises:
physically coupling the wireless host to a first upstream port of the USB switching hub;
physically coupling a wireless bridge to a downstream port of the USB switching hub; and
implementing an association protocol between the wireless host and the wireless bridge.

14. The method of claim 12, wherein associating the wireless host comprises entering a code from one of the wireless host and the wireless bridge to the other of the wireless host and the wireless bridge.

15. The method of claim 11, further comprising:
the wired host enumerating the USB switching hub using a first hub configuration for the USB switching hub;
the wireless host enumerating the USB switching hub using a hub configuration substantially similar to the first hub configuration for the USB switching hub; and
switching communications between at least one of the plurality of downstream devices and the wired host to the wireless host.

16. The method of claim 15, wherein the wireless host is not required to re-enumerate the USB switching hub when communications are switched.

17. The method of claim 11, wherein the wired host communicates with at least a subset of a plurality of downstream devices coupled to the USB switching hub substantially simultaneously with the wireless host communicating with at least a subset of a plurality of downstream devices coupled to the USB switching hub.

18. A system, comprising:
a Universal Serial Bus (USB) switching hub, comprising:
a plurality of upstream ports;
a plurality of downstream ports; and
downstream switching logic coupled between the plurality of upstream ports and the plurality of downstream ports;
wherein a first upstream port of the plurality of upstream ports is operable to couple to a first host;
wherein a second upstream port of the plurality of upstream ports is operable to communicate with a second wireless host;
wherein the at least a subset of downstream ports of the plurality of downstream ports are accessible to the first upstream port and the second upstream port;
wherein the USB switching hub is configured to be enumerated with a substantially similar hub configuration by each of the plurality of upstream devices coupled to its respective one of the plurality of upstream ports.

19. The system of claim 18, wherein the USB switching hub is operable to switch communications without upstream devices coupled to the first host and the second wireless host being required to re-enumerate the USB switching hub.

20. The system of claim 18, further comprising delaying switching communications of the subset of the plurality of downstream ports if there is an active transfer in progress between the downstream port and the first upstream port, wherein switching communications is delayed by an intelligent port routing switch.

21. The system of claim 1, wherein the first host is a second wireless host.
